(19) United States
(12) Patent Application Publication
(10) Pub. No.: US 2025/0056285 A1
(43) Pub. Date: Feb. 13, 2025

(54) METHODS, DEVICES, AND MEDIUM FOR COMMUNICATION

(71) Applicant: NEC CORPORATION, Tokyo (JP)

(72) Inventors: Peng GUAN, Beijing (CN); Yukai GAO, Beijing (CN); Gang WANG, Beijing (CN)

(73) Assignee: NEC CORPORATION, Tokyo (JP)

(21) Appl. No.: 18/720,739

(22) PCT Filed: Dec. 23, 2021
(86) PCT No.: PCT/CN2021/140925

§ 371 Date: Jun. 17, 2024

(51) Int. Cl. H04W 24/10; H04B 17/318; H04B 17/336; H04L 5/00

(52) U.S. Cl. CPC H04W 24/10; H04B 17/328; H04B 17/336; H04L 5/0048

(57) ABSTRACT

Example embodiments of the present disclosure relate to an effective mechanism for handling the panel-related information. In this solution, the terminal device transmits a correspondence report to a network device, where the correspondence report indicates a first correspondence between at least one first capability value set and at least one first RS. The terminal device further communicates with the network device according to a feedback state of the correspondence report, where the feedback state is an ACK or a NACK. In this way, the misalignment between the network device and the terminal device is avoided.

### FIELD

Example embodiments of the present disclosure generally relate to the field of communication techniques and in particular, to methods, devices, and medium for handling the panel-related information.

### BACKGROUND

In order to meet the increasing wireless data traffic demand, a plurality of schemes have been proposed and implemented, where the multiple input multiple output (MIMO) technology is considered as one powerful scheme to achieve high data throughputs in the communication system. MIMO includes features that facilitate utilization of a large number of antenna elements at a network device (such as, a base station, BS) for both sub-6 GHZ and over-6 GHz frequency bands.

Further, it is proposed that a terminal device (such as, a user equipment) may be deployed with more than one antenna element (also referred to as panel sometimes). In the 3rd-generation partnership project (3GPP) release 17 (Rel-17), it has been agreed that the terminal device and the network device may exchange panel-related information. Specifically, a list of sets of capability parameters (also referred to as “UE capability value sets” or “capability value sets” sometimes) may be reported to the network device. Further, a correspondence report (for example, a beam report) indicating a correspondence between each reported reference signal (RS) index and one of the set of capability parameters in the reported list is proposed to be transmitted to network device, such that the terminal device may perform a user equipment (UE)-initiated panel activation and selection procedure. However, the details for handling (such as, configuring, reporting and feeding back and so on) the panel-related information are still needed to be further discussed.

### SUMMARY

In general, example embodiments of the present disclosure provide a solution for handling the panel-related information. Embodiments that do not fall under the scope of the claims, if any, are to be interpreted as examples useful for understanding various embodiments of the disclosure.

In a first aspect, there is provided a method of communication. The method comprises: transmitting, at a terminal device, a correspondence report to a network device, the correspondence report indicating a first correspondence between at least one first capability value set and at least one first RS; and communicating with the network device according to a feedback state of the correspondence report, the feedback state being one of the following: an acknowledgment (ACK), or a negative-acknowledgement (NACK).

In a second aspect, there is provided a method of communication. The method comprises: determining, at a terminal device, a default capability value set; and performing at least one of the following: performing an initial transmission with network device by applying the default capability value set; or if a fallback condition meets, falling back to apply the default capability value set after transmitting a correspondence report to the network device, the correspondence report indicating a correspondence between a capability value set and a RS to the network device.

In a third aspect, there is provided a method of communication. The method comprises: receiving, at a network device, a correspondence report from a terminal device, the correspondence report indicating a first correspondence between at least one first capability value set and at least one first RS; and communicating with the terminal device according to a feedback state of the correspondence report, the feedback state being one of the following: an ACK, or a NACK.

In a fourth aspect, there is provided a method of communication. The method comprises: determining, at a network device, a default capability value set; and performing at least one of the following: performing an initial transmission with terminal device by applying the default capability value set; or if a fallback condition meets, falling back to apply the default capability value set after receiving a correspondence report from the terminal device, the correspondence report indicating a correspondence between a capability value set and a RS from the terminal device.

In a fifth aspect, there is provided a terminal device. The terminal device includes a processing unit; and a memory coupled to the processing unit and storing instructions thereon, the instructions, when executed by the processing unit, causing the device to perform the method according to the first aspect.

In a sixth aspect, there is provided a terminal device. The terminal device includes a processing unit; and a memory coupled to the processing unit and storing instructions thereon, the instructions, when executed by the processing unit, causing the device to perform the method according to the second aspect.

In an seventh aspect, there is provided a network device. The network device includes a processing unit; and a memory coupled to the processing unit and storing instructions thereon, the instructions, when executed by the processing unit, causing the device to perform the method according to the third aspect.

In an eighth aspect, there is provided a network device. The network device includes a processing unit; and a memory coupled to the processing unit and storing instructions thereon, the instructions, when executed by the processing unit, causing the device to perform the method according to the fourth aspect.

In a ninth aspect, there is provided a computer readable medium having instructions stored thereon, the instructions, when executed on at least one processor, causing the at least one processor to carry out the method according to any of the above first to fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrated an interaction timing 100 between the network device and the terminal device in the related solution;

FIG. 2 illustrates an example communication environment in which example embodiments of the present disclosure can be implemented;

FIG. 3 illustrates a signaling chart illustrating a process for communication according to some embodiments of the present disclosure;

FIG. 4 illustrates an example interaction timing according to some embodiments of the present disclosure;

FIG. 5 illustrates an example interaction timing according to some embodiments of the present disclosure;

FIGS. 6A and 6B illustrate example interaction timings according to some embodiments of the present disclosure;

FIG. 7 illustrates an example method performed by the terminal device according to some embodiments of the present disclosure;

FIG. 8 illustrates an example method performed by the terminal device according to some embodiments of the present disclosure;

FIG. 9 illustrates an example method performed by the network device according to some embodiments of the present disclosure;

FIG. 10 illustrates an example method performed by the network device according to some embodiments of the present disclosure; and

FIG. 11 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, UE, personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As discussed above, it is proposed that a terminal device may be deployed with more than one antenna element (also referred to as panel sometimes). Further, it has been agreed that the terminal device may report the panel-related information to the network device. However, the details for handling (such as, configuring, reporting and feeding back and so on) the panel-related information are needed to be further discussed.

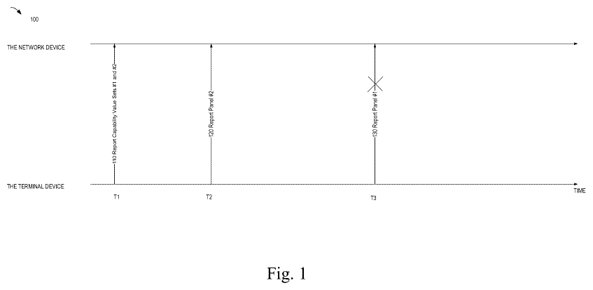

Reference is now made to FIG. 1, which illustrated an interaction timing 100 between the network device and the terminal device in the related solution. In the specific example of FIG. 1, the terminal device is deployed with two panels (indexed to be panel #1 and panel #2), where panels #1 and #2 correspond to the UE capability value sets #1 and #2, respectively. Further, the UE capability value set #1 is associated with beams #1 and #2 and supports 2-port sounding reference signal (SRS) while the UE capability value set #2 is associated with beams #3 and #4 and supports 4-port SRS.

In operation, the terminal device may determine which beam can be used for uplink transmission for different panels by, e.g., measuring downlink RS, and the terminal device may reveal some of its panel capability and structure to the network device. As illustrated in FIG. 1, at time point T1, the terminal device may report 110 a list of UE capability value sets via such as a RRC signalling. However, it is still pending about which parameters should be comprised in the UE capability value sets.

Further, it has been agreed that a correspondence report indicating a correspondence between each reported RS index and one of the UE capability value sets is transmitted to network device. As illustrated in FIG. 1, at time point T2, the terminal device transmits 120 a correspondence report associated with panel #2 (i.e., UE capability value set #2) to the network device, and transmits 130 a further correspondence report associated with panel #1 (i.e., UE capability value set #1) to the network device. However, it is still pending about the format of the correspondence report and how to configure the reporting of the correspondence report.

Further, due to the complicated communication environments, it is not ensured that the transmission of the correspondence report is always successful. As illustrated in FIG. 1, the transmission of the further correspondence report is failed. In this event, after transmitting the further correspondence report, the terminal device may consider to apply the UE capability value set #1, while the network device still applies the UE capability value set #2. Therefore, the transmission failure of the further correspondence report causes a misalignment between the network device and the terminal device with regard to the uplink transmission capability. In the specific example of FIG. 1, after the time point T3, the network device may request the terminal device to transmit SRS/physical uplink shared channel (PUSCH) with 4 antenna ports which cannot be supported by the terminal device. Additionally, the network device may schedule the terminal device to transmit with beams #3 and #4, while the terminal device merely support to transmit with beams #1 and #2. In summary, the misalignment between the network device and the terminal device results that the communication between the network device and the terminal device cannot be preceded normally.

Therefore, it seems that a feedback mechanism for the correspondence report is needed. It can be solved by introducing new message/signaling, including a new radio network temporary identifier (RNTI), or a new downlink control information (DCI) format or field, for the feedback for the correspondence report. However, the introduction of new message/signaling may cause additional overhead and complexity, which is not preferred. In this event, how to implement the feedback mechanism for the correspondence report needs further discussion.

Further, the correspondence report may cause a switch/change among different panels/UE capability value sets/RSs/beams. It is required that such switch/change should be aligned at both of the network device and the terminal device. Therefore, the switching operations at the network device and the terminal device during the feedback procedure also should be detailed stipulated.

Still refer to FIG. 1, it can be seen that during a period between the time point T1 and the time point T2, as no correspondence report has been transmitted to the network device, both of the network device and the terminal device do not know which panel/UE capability value set/RS/beam should be applied. Therefore, it is also desirable to propose a solution about how to perform an initial transmission between the network device and the terminal device.

In addition, a fallback procedure is usually needed during the communication procedure. So far, it is still pending about the fallback procedure after transmitting the correspondence report.

In addition to the above, there are still other pending issues, include but are not limited to, whether the UE capability value set can be common across all bandwidth parts (BWPs)/component carriers (CCs) in same band or band combination, whether/how to implement to report downlink only panel-related information, how to configure the time-domain behaviour of the correspondence report and so on.

According to some of the embodiments, at least part of the above illustrated pending issues will be addressed. It should be understood that the above illustrated issues are only for the purpose of illustration without suggesting any limitations. Both of the pending issues and the issues addressed by the present disclosure also are not limited to the above illustrated issues.

Generally speaking, one panel discussed herein refers to one or more antenna elements deployed at a certain area of a terminal device. In this regard, the terms (and their equivalent expressions) “panel”, “antenna element(s)”, “antenna array(s)”, “transmission reception point(s)”, “TRPs” can be used interchangeably.

In some embodiments, the terminal device may be configured with a list of transmission configuration indicator (TCI) states (such as, up to M TCI-State) configurations with tci-StateId. Each TCI-State comprises parameters for providing a RS for the quasi-colocation (QCL) for demodulation reference signal (DM-RS) of physical downlink shared channel (PDSCH) and DM-RS of physical downlink control channel (PDCCH) in a component carrier (CC), CSI-RS, and to provide a reference, if applicable, for determining unlink TX spatial filter for dynamic-grant and configured-grant based physical uplink shared channel (PUSCH) and physical uplink control channel (PUCCH) resource in a CC, and SRS. The quasi co-location relationship is configured by the higher layer parameter qcl-Type1 for the first RS, and qcl-Type2 for the second RS (if configured). The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The terms “TCI”, “TCI state”, “TCI identify”, “TCI ID”, “TCI state ID” can be used interchangeably.

The terms “set of capability parameters”, “capability value set”, “UE capability value set” can be used interchangeably.

In addition, in the present discourse, the terms (and their equivalent expressions) “CC identity/index”, “cell identity/index” and “serving cell identity/index” can be used interchangeably.

In some embodiments, the terms “RS(s)”, “beam”, “set of QCL parameters”, “TCI state”, “QCL type”, “QCL typeD”, “spatial reception parameter”, “spatial domain parameter”, “spatial domain filter”, “spatial domain transmission filter”, “spatial domain receiving filter”, “spatial receiving parameter” and “spatial relation info” refer to the same similar meanings and may be used interchangeably.

In some embodiments, a panel/capability value set may refer to a downlink panel/capability value set, an uplink panel/capability value set, a panel/capability value set with a reserved/specific state, a panel/capability value set type, a panel/capability value set status, an RS resource, an RS resource set, an antenna port, an antenna port group, a beam, an beam group.

In some embodiments, panel identity information may refer to an index/identity of a panel, an index/identity of downlink panel, an index/identity of uplink panel, a panel type indication, a panel status indication, a capability value set index, an RS resource set index/identity, an antenna port index/identity, an antenna port group index/identity, a beam group index/identity.

### Example Environment

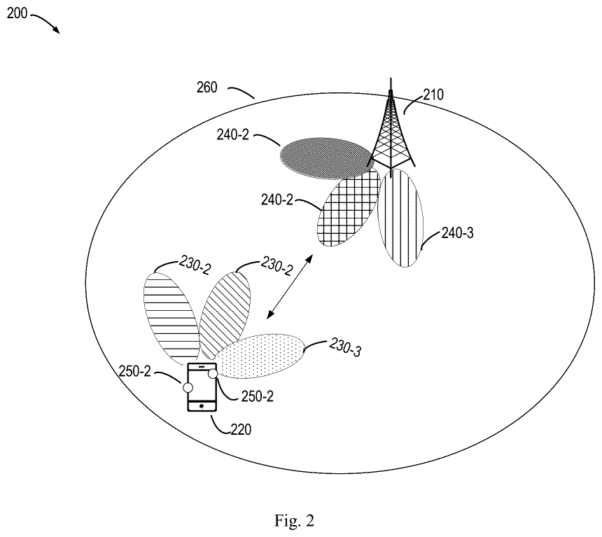

FIG. 2 shows an example communication environment 200 in which example embodiments of the present disclosure can be implemented.

The communication environment 200 includes a network device 210 and a terminal device 220, and further the network device 210 can communicate with the terminal device 220 via physical communication channels or links. Additionally, the network devices 210 may provide more than one serving area. In the specific example of FIG. 2, the network device 210 provides (serving) cell 260.

In the specific example of communication environment 200, a link from the terminal device 220 to the network device 210 is referred to as uplink, while a link from the network device 210 to the terminal device 220 is referred to as a downlink. Further, the MIMO is supported in the communication environment, such that the network device 210 and the terminal device 220 may communicate with each other via different beams to enable a directional communication. In downlink, the network device 210 is a transmitting (TX) device (or a transmitter) and the terminal device 220 is a receiving (RX) device (or a receiver), and the network device 210 may transmit downlink transmission to the terminal device 220 via one or more beams. As illustrated in FIG. 2, the network device 210 transmits downlink transmission to the terminal device 210 via the beams 240-1 to 240-3.

Correspondingly, in uplink, the network device 210 is a RX device (or a receiver) and the terminal device 220 is a TX device (or a transmitter), and the terminal device 220 may transmit uplink transmission to the network device 210 via one or more beams. As illustrated in FIG. 2, the terminal device 220 transmits uplink transmission to the network device 210 via the beams 230-1 to 230-3. For purpose of discussion, the beams 230-1 to 230-3 or beams 240-1 to 240-3 are collectively or individually referred to as beam 230 or beam 240, respectively.

In addition, the terminal device 220 may be deployed with more than one panel. As illustrated in FIG. 2, the terminal device 220 is deployed with panels 250-1 and 250-2. In the following, the panels 150-1 and 250-2 may be referred to as the first panel 250-1 and the second panel 250-2, respectively. In some embodiments, panels 250-1 and 250-2 may correspond to different sets of capability parameters, respectively.

In some embodiments, one panel may be associated with one or more RSs/beams. In this way, the terminal device 220 may use a specific panel to transmit the directional signal to the network device 210 via specific beam(s) associated with the RS(s).

In some embodiments, different panels correspond to different panel types/capability value sets. For example, the panels 250-1 and 250-2 may correspond to different number of SRS ports, frequency resource (frequency band, CC, beam and so on) and any other suitable capability parameters (such as, capability value sets).

Further, in the specific example of FIG. 2, the exchanging of panel-related information is supported. Specifically, in the specific example of FIG. 2, the network device 210 and the terminal device 220 may exchange capability-related information and related configuration, and the terminal device 220 may report correspondence report(s) to the network device 210.

In some embodiments, the terminal device 220 may perform a UE-initiated panel activation and selection via reporting a list of UE capability value sets.

In some embodiments, one or more RS (such as, synchronization signal/physical broadcast channel (SS/PBCH) block, SSB, sounding reference signal, SRS, CSI-RS, and so on) may be associated with one beam. The terminal device 220 may measure on the beams/RSs and transmit the measurement result to the network device 210 via such as a correspondence report.

Further, the correspondence between each reported CSI-RS and/or SSB resource index and one of the set of capability parameters in the reported list is determined by the terminal device 220/configured by the network device 210 and is informed to network device 210 in a beam reporting instance.

In some embodiments, the index of the corresponding set of capability parameters is reported along with the pair of SSB resource indicator (RI)/CSI-RS resource indicator (CRI) and L1-RSRP/SINR (up to 4 pairs, with 7-bit absolute and 4-bit differential) in an uplink control information for beam reporting.

Additionally, the terminal device 220 may report one index for all the reported CRIs/SSB RIs in one beam reporting. Alternatively, the terminal device 220 may report one index for each reported CRI/SSB RI in one beam reporting.

In some embodiments, a DL-only corresponding report is supported which will be discussed in the following text.

In some embodiments, the network device 210 provides configurations (such as, a time domain behavior of the correspondence report, a format of the correspondence report) and resources (such as, the physical uplink control channel (PUCCH)/physical uplink shared channel (PUSCH) resources, the beam(s), the RSs and so on) for the correspondence report. Further, the configurations also indicate when/how/where to report the correspondence report.

In some embodiments, the corresponding report may be configured with any suitable time domain behavior. One example of the time domain behavior is periodic. Another example of the time domain behavior is semi-persistent. A further example of the time domain behavior is aperiodic.

The communications in the communication environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their interrelationship of network device, terminal device, panel and cell are only for the purpose of illustration without suggesting any limitations. The communication environment 200 may include any suitable network device, terminal device, panel and cell adapted for implementing embodiments of the present disclosure. Further, it is to be understood that one or more additional terminal devices may be located in the respective cells.

It would also be appreciated that in some examples, only the homogeneous network deployment or only the heterogeneous network deployment may be included in the communication environment 200.

### Example Processes

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 220 and the network device 210 (such as, exchanging capability-related information, configuration and so on). It is to be understood that the interactions may be implemented either in one single signaling/message or multiple signaling/messages, including system information, RRC message, DCI message, uplink control information (UCI) message, media access control (MAC) control element (CE) and so on. The present disclosure is not limited in this regard.

In the following, a layer 1-reference signal received power (L1-RSRP)/L1-signal to interference and noise ratio (L1-SINR) will be used as an example of signal measurement result for describing some specific example embodiments of the present disclosure. It is to be understood that example embodiments described with regard to the L1-RSRP/L1-SINR may be equally applicable to other type of signal measurement result, including but not limited to L3-RSRP, L3-SINR, L1/L3 received signal strength indicator (RSSI), L1/L3 reference signal received quality (RSRQ), and so on. The present disclosure is not limited in this regard.

Further, it is to be understood that the operations at the terminal device 220 and the network device 210 should be coordinated. In other words, the network device 210 and the terminal device 220 should have common understanding about configuration, state, parameters and so on. Such common understanding may be implemented by any suitable interactions between the network device 210 and the terminal device 220 or both the network device 210 and the terminal device 220 applying the same rule/policy. In the following, although some operations are described from a perspective of the terminal device 220, it is to be understood that the corresponding operations should be performed by the network device 210. Similarly, although some operations are described from a perspective of the network device 210, it is to be understood that the corresponding operations should be performed by the terminal device 220. Merely for brevity, some of the same or similar contents are omitted here.

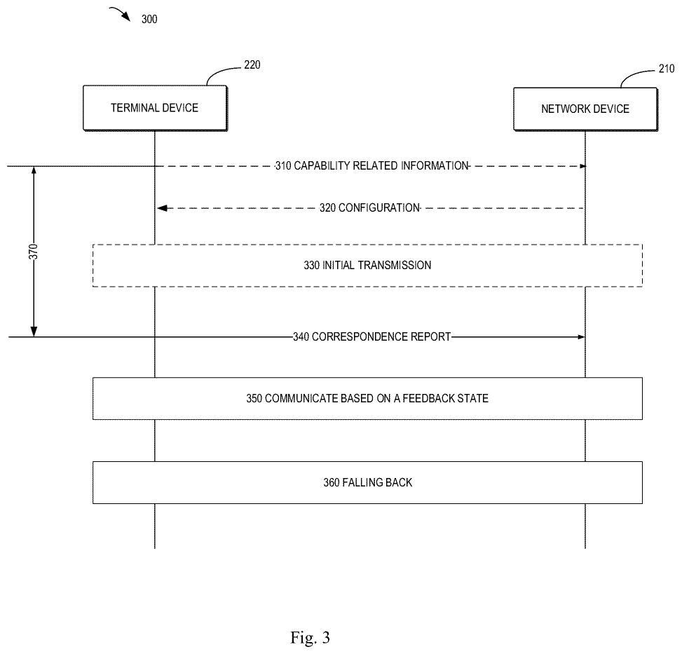

Principle and implementations of the present disclosure will be described in detail below with reference to FIG. 3, which shows a signaling chart illustrating a process 300 of communication according to some example embodiments of the present disclosure. For the purpose of discussion, the process 300 will be described with reference to FIG. 2. The process 300 may involve the terminal device 220 and the network device 210.

Further, the terminal device 220 may be deployed with more than one panel (such as, panel 250-1 and panel 250-2) and supports more than one more than one capability value sets. Both of the panels and the capability value sets may be indexed according to an ascending or descending order.

### Example Processes for Exchanging Capability-Related Information

Optionally, the terminal device 220 and the network device 210 may communicate capability-related information and related configuration to enable the related features according to the present disclosure, which will be discussed as below. During this interactive procedure, certain rules for configuring and reporting the correspondence report may be stipulated, and the related re-defined/newly-introduced parameters may be exchanged between the terminal device 220 and the network device 210. Additionally, the network device 210 may enable or disable the related features according to the present disclosure.

As illustrated in FIG. 3, the terminal device 220 transmits 310 the capability-related information to the network device 210. According to some example embodiments of the disclosure, more fields for indicating the panel capability of the terminal device 220 are comprised in capability-related information (such as, via one or more capability reports). In this way, a better alignment of the panel capability and the panel structure between the network device 210 and the terminal device 220 may be achieved.

In addition, the capability-related information and the related configuration may be carried in any suitable signalling/message(s), including but not limited to RRC message, DCI message, MAC CE and so on. In this way, the existing signaling structure may be reused and updated to accommodate to the reporting of CSI report associated with a set of capability parameters.

In some embodiments, the capability-related information may indicate the capability-related information indicating a plurality of capability value sets supported by the terminal device 220 (such as, L sets of capability value sets, where the value of L may be a positive integer).

In some embodiments, one capability value set may be associated with one or more RSs (such as, SSB resource indicator, SSBRI, CSI-RS resource indicator, CRI), while one RSs also may be associated with one or more capability value set. In other words, the correspondence between the capability value set and RS may be 1-to-1, 1-to-many, many-to-1, many-to-many.

Further, many capability parameter may be comprised in the capability value set. One capability parameter comprised in the set is a maximum number of SRS ports (be represented as “Nx”). The maximum number of SRS ports Nx refers to Nx radio frequency (RF) chains for uplink transmission, and Nx layers for PUSCH.

Alternatively, or in addition, other capability parameters comprised in the set may be any suitable parameters, including but not limited to:
identity information of the capability value set,
a maximum number of SRS ports,
a maximum number of SRS resources,
a maximum number of SRS resource sets,
a coherent type (such as, full coherent, partial coherent, non-coherent, and their combinations),
a maximum number of uplink layers,
a maximum number of downlink layers,
a maximum number of RS (such as, CSI-RS) ports,
a maximum number of codewords, or
a maximum number of MIMO layers.

By reporting more capability parameters in each capability value set to the network device 210, the network device 210 may well understand the capability of the terminal device 220, and may proceed with a more proper scheduling for the terminal device 220.

Further, in addition to the list of capability value sets, more capability-related information may be reported to the network device 210 as discussed below.

In some embodiments, one capability value set corresponds to a panel (a physical or a logical entity) deployed at a terminal device 220. In other words, each capability value set corresponds to one panel. In this event, the values of capability parameters comprised in different capability value sets may be the same.

Alternatively, or in addition, in some embodiments, one capability value set may correspond to a specific panel type. In this event, the values of capability parameters comprised in different capability value sets are different (or at least partially different). In one example embodiment, the type of the panel may be defined by the supported number of SRS ports, such as, type #1 corresponding to 1-port SRS, type #2 corresponding to 2-port SRS, type #3 corresponding to 4-port SRS and the likes.

Further, in some embodiments, the capability-related information indicates whether a symmetric antenna structure (i.e., symmetric panels) or an asymmetric antenna structure (i.e., asymmetric panels) is deployed at the terminal device. Alternatively, or in addition, in some embodiments, the capability-related information indicates a respective number of capability value set corresponding to each specific type of capability value set.

In one specific example embodiments, the capability-related information indicates: a capability value set #1 (including a capability value of the 2-port SRS) with a respective number of 2, which means that the terminal device 220 is equipped with two panels and both panels can support 2-port SRS. In another specific example embodiments, in case that the terminal device 220 is equipped with two panels, the capability-related information indicates: a capability value set #2 (including a capability value of the 4-port SRS) and a symmetric antenna structure, which means that the terminal device 220 is equipped with two panels and both panels can support 4-port SRS. For brevity, other exemplary embodiments are not discussed one by one.

Alternatively, or in addition, in some embodiments, one capability value set may correspond to a specific panel status. In one example embodiment, the panel status may be defined by the activated number of panels, such as, status #1 corresponding to single-panel transmission, status #2 corresponding to two-panel simultaneous transmission, status #3 corresponding to four-panel simultaneous transmission and the likes. This example embodiment is especially suitable the scenario where the multi-panel simultaneous transmission is supported.

In one example embodiment, the capability-related information further indicates an association relationship among the plurality of capability value sets. In some embodiments, the capability-related information indicates that whether one of reported capability value set is a subset of another reported capability value set.

In one specific example embodiment, the capability-related information indicates whether the reported capability value set with smaller values (such as, identity information) is a subset of the reported capability value set with larger values. In other words, the reported capability value set with larger values refers to a simultaneous multi-panel status while the reported capability value set with smaller values refers to a single-panel status.

For example, the capability-related information indicates: a capability value set #1 (including a capability value of the 2-port SRS), a capability value set #2 (including a capability value of the 2-port SRS), and indicates that the capability value set #1 with 2-port SRS is a subset of the capability value set #2 with 4-port SRS. Such capability-related information means that the terminal device 220 can transmit up to 4-port SRS with simultaneous multi-panel, and transmit up to 2-port SRS with single panel.

Alternatively, or in addition, in some embodiments, the capability-related information may indicate whether the terminal device 220 supports to apply more than one capability value set concurrently. Additionally, the capability-related information may further indicate the number of capability value set supported to be concurrently applied by the terminal device 220. For example, the capability-related information indicates: a capability value set #1 (including a capability value of the 2-port SRS), a capability value set #2 (including a capability value of the 4-port SRS) and capability value sets #1 and 2 can be used simultaneously, which means that the terminal device 220 can support up to 6-port SRS.

Additionally, a concept of state of capability value set may be introduced. Specifically, the state of capability value set may indicate that a capability value set is used for an uplink transmission or a capability value set is used for a downlink transmission. Additionally, the state of capability value set may indicate some reserved states, such as, an application state of a capability value set which indicates whether the capability value set has been applied or is to be applied. Alternatively, or in addition, In some embodiments, the state of capability value set may indicate whether the applied capability value set has been changed or is to be changed. In one specific example embodiment, the state of capability value set may indicate one of the following: the capability value set being used for uplink, the capability value set being used for downlink (i.e., only for downlink panel/not related to uplink panel), the capability value set being not suitable for uplink transmission (i.e., the terminal device 220 cannot use the reported capability value set for uplink transmission), the applied capability value set having been changed or is to be changed and so on.

Due to introducing the concept of state of capability value set, in some embodiments, the capability-related information also may indicate whether the terminal device 220 supports to report a correspondence report for downlink transmission. Additionally, the capability-related information also may indicate whether the terminal device 220 supports to report a reserved state of capability value set.

As discussed above, the identity information of the capability value set may be comprised in the capability value set. Thus, the identity information may be used for identifying/indexing the capability value set.

Further, the identity information of the capability value set may be indicated either by an explicit manner or an implicit manner. Specifically, the terminal device may report an explicit identify information (such as, a number/index) of the capability value set to the network device 210. Alternately, as for the implicit manner, the identify information of the capability value set is not necessarily comprised in the capability-related information. In this event, the number/index of the related capability value set may be implied. In one specific example embodiment, the number/index of the capability value set is determined based on the number of the SRS ports associated with the capability value set according to an ascending or descending order. In another specific example embodiment, the number/index of the capability value set is determined based on reporting order of the capability value sets according to an ascending or descending order.

In some embodiments, the reported/determined number/index of the capability value set may be represented as a bit sequence (such as, a panel information field) in the correspondence report, such that the capability value set may be indicated/reported to the network device 210. A bit size of the bit sequence comprised in the correspondence report is determined based on a first number of sets of capability-related parameters supported by the terminal device 220 i.e., L. Specifically, the bit size is calculated as ceil (log 2(L)).

Alternatively, or in addition, in some embodiments, a bit size of the bit sequence comprised in the correspondence report is determined based on a second number of the states of the capability value set supported by the terminal device 220. In one specific example embodiment, one or more specific index/identity information may be assigned for indicating that the capability value set is used for downlink, such as, N, where N may be “1” or other positive integer. Considering such specific index, the bit size of the bit sequence comprised in the correspondence report may be calculated as ceil (log 2(L+N)).

In another specific example embodiment, one or more specific values of the index/identity information may be assigned for indicating that the capability value set is used for reserved states, such as, M, where M may be “1” or other positive integer. Considering such specific index, the bit size of the bit sequence comprised in the correspondence report may be calculated as ceil (log 2(L+M)).

It is to be understanding, such indexing mechanism may be used for any interacting procedure between the network device 210 and the terminal device 220, such as, indexing the capability value set comprise in the correspondence report as discussed below.

Alternatively, or in addition, in some embodiments, the capability-related information also may indicate other capabilities of the terminal device 220, including but not limited to, whether the terminal device 220 supports to determine the feedback state of the correspondence report; whether the terminal device 220 supports to report a state of a capability value set; whether the terminal device 220 supports to obtain the correspondence with a time restriction; or a number of capability value sets comprised in a correspondence report supported by the terminal device 220 and so on.

It should be understood that the above illustrated capability-related information are only for the purpose of illustration without suggesting any limitations. In some other example embodiments, any suitable capability-related information may be used.

Still refer to FIG. 3, the network device 210 transmits 320 one or more configurations to the terminal device 220.

In one example embodiment, the one or more configurations may be generated based on the capability-related information received from the terminal device 220. In another example embodiment, the measurement configuration is generated independently from the capability-related information.

In one example embodiment, the one or more configurations indicate association relationships between at least one transmission parameter and a capability value set.

One example of the transmission parameters is a resource for transmitting SRS, such as, SRS resource set and SRS resource. Specifically, at least one of SRS resource sets, SRS resources, SRS ports can be associated with the capability value set. For example, the one or more configurations associates SRS resource set #1 with capability value set #1, while the number of ports of the SRS resources in the SRS resource set #1 is less than the number of SRS port reported in the capability value set #1.

Additionally, in one example embodiment, the terminal device 220 performs a SRS transmission based on both of the at least one configuration and one or more capability value sets currently applied at the terminal device 220. In other words, the terminal device 220 is not expected to transmit all configured SRS resources, and the terminal device 220 could select SRS resources according to its current panel state (i.e., currently applied panel(s)).

Another example of the transmission parameters is a resource for transmitting PUCCH. Specifically, at least one of PUCCH resources, PUCCH Resource sets, PUCCH resource groups can be associated with the capability value set.

The other examples of the transmission parameters are TCI state(s) and resource(s) for transmitting downlink RS. Specifically, TCI state(s), downlink RS resources/resource sets/ports also may be associated with capability value set.

Below table 1 illustrates example association relationships between the transmission parameters and two capability value sets.

TABLE 1
example association relationships

| Capability value set 1 | Capability value set 2 |
|---|---|
| SRS resource sets/resources/ports {a1, b1, . . . } | SRS resource sets/resources/ports {a2, b2, . . . } |
| PUCCH resources/Resource sets/resource | PUCCH resources/Resource sets/resource |
| groups {c1, d1, . . . } | groups {c2, d2, . . . } |
| TCI states {e1, f1, . . . } | TCI states {e2, f2, . . . } |
| DL RS resources {g1, h1, . . . } | DL RS resources {g2, h2, . . . } |

Alternatively, or in addition, in some embodiments, the one or more configurations indicate report quantity of the correspondence report. In other words, the network device 210 may configure the content comprised in the correspondence report. By indicating the report quantity, the network device 210 may instruct the terminal device 220 to report the panel information, such as, the identify information of the capability value set as discussed above, the SSBRI/CRI, the RSRP/SINR, the related correspondence and so on.

Alternatively, or in addition, in some embodiments, the one or more configurations indicate a time domain behavior of the correspondence report.

In one example specific embodiment, the one or more configurations indicate the correspondence report is periodic report. Additionally, the periodicity of the correspondence report can be linked to other periodic beam report without panel info report. For example, the correspondence report is configured with a first periodicity by the at least one configuration, and further the first periodicity is aligned with a second periodicity of a beam report, and the first periodicity is a multiple of second periodicity. In other words, if the beam report is configured with a periodicity T and N times the periodicity (i.e., N*T) configured for beam report without panel info (e.g., SSBRI/CRI-RSRP/SINR), then every N*T the beam report (SSBRI/CRI-RSRP/SINR) can be replaced by the panel info-beam report (i.e., the correspondence report).

In some embodiments, the semi-persistent and/or aperiodic time domain behavior can be configured associated with the periodic time domain behavior. Specifically, in some embodiments, the triggering of the semi-persistent time domain behavior and the aperiodic time domain behavior is conditionally. In some embodiments, the semi-persistent time domain behavior and/or the aperiodic time domain behavior is triggered/allowed only when the periodic time domain behavior is configured. Additionally, in some embodiments, the aperiodic time domain behavior triggered/allowed only when the semi-persistent time domain behavior is configured.

It is to be understood that the association/configuration limitations among periodic, semi-persistent and aperiodic time correspondence report may be indicated by either an explicit manner (such as, indicating the linkage between different reports) or an implicit manner.

Alternatively, or in addition, the one or more configurations indicate information about time restriction for obtaining the correspondence report. Alternatively, or in addition, the one or more configurations indicate a number of capability value sets associated with one correspondence report. Other information indicates by the one or more configurations may be discussed in the following text.

It should be understood that the above illustrated interaction procedures are only for the purpose of illustration without suggesting any limitations. In some other example embodiments, any suitable other interaction procedures may be performed.

### Example Processes for Initial Transmission

As discussed previously, in case that no correspondence report has been transmitted to the network device 210, both of the network device 210 and the terminal device 220 do not know which panel/capability value set/beam should be applied. In the following embodiments, this pending issue may be well handled.

According to some embodiments of the present disclosures, the initial transmission may be performed during one of the below periods:
a period between reporting at least capability value set and transmitting the first correspondence report,
a period between an initial access and transmitting the first correspondence report,
a period between an initial configuration and transmitting the first correspondence report, or
a period between an initial configuration and transmitting the first correspondence report.

It is to be understood that the above periods are only for the purpose of illustration without suggesting any limitations. In some other example embodiments, the initial transmission may be performed in suitable periods during which the network device 210 and the terminal device 220 do not know the transmission parameters (such as, panel, capability value set, beam, RS and so on). The present disclosure is not limited in this regard.

In the specific example embodiment of FIG. 3, during the period 370 (i.e., a period between reporting at least capability value set and transmitting the first correspondence report), the terminal device 220 and the network device 210 may communicate 330 with each other by using a default capability value set, which may referred to as an initial transmission.

In this way, as the network device 210 and the terminal device 220 have a common understanding about the communication parameter (i.e., the capability value set/panel), even if no correspondence report has been transmitted to the network device 210, the network device 210 and the terminal device 220 also can communicate with each other.

The default set of capability parameters may be determined by any suitable policy/rule. In one example embodiment, the set of capability parameters with the minimum/maximum/pre-configured index value may be used as the default set of capability parameters. Alternately, in another example embodiment, the set of capability parameters with the minimum/maximum number of SRS ports may be used as the default set of capability parameters. Alternately, in another example embodiment, the set of capability parameters with a lower or lowest value of index may be used as the default set of capability parameters.

Examples of the default capability value set are illustrated as below:
a capability value set with a lower capability,
a capability value set with a higher capability,
a capability value set with a lower capability value set index,
a capability value set with a higher capability value set index,
a last used capability value set,
a pre-defined capability value set,
a capability value set configured either by the terminal device 220 or the network device 210.

It is to be understood that the above-discussed default capability value set are only for the purpose of illustration without suggesting any limitations. In some other example embodiments, any suitable policy/rule may be applied for determining the default set of capability parameters. In other words, it can be any pre-defined rule known at both the network device 210 and the terminal device 220 side, or signaled by the network device 210/the terminal device 220 each to other by signalling (such as, configuration/capability-related signalling).

In some embodiments, the terminal device 220 transmits the information about the default capability value set during a random access (RA) procedure. Specifically, the information about the default capability value set is carried on one physical random access channel (PRACH). In one example embodiment, the information about the default capability value set is included in a message 3 during a 4-step RA. Alternately, in another example embodiment, the information about the default capability value set is included in a message A during a 2-step RA.

In some embodiments, the network device 210 may generate a scheduling message generated according to the default capability value set. Correspondingly, the terminal device 220 may transmit an uplink transmission with the network device 220 by applying the default capability value set.

In some embodiments, the scheduling message/uplink transmission is associated with an SRS transmission. Specifically, only the SRS resource set/resource/port associated with the default capability value set is scheduled/used/assumed. For example, if the terminal device 220 reports two capability values sets, i.e., capability value set #1 corresponding to maximum 2-port SRS and capability value set #2 corresponding to maximum 4-port SRS. If the capability value set with a lower capability is assumed as the default capability value set. During the initial transmission, SRS resources with 4-port are not scheduled/transmitted. In other words, the terminal device 220 does not expect (or, is not expected) to transmit more than 2-port SRS.

Alternatively, or in addition, in some embodiments, the scheduling message/uplink transmission is associated with a PUSCH transmission. Specifically, only the SRS resource set/resource/port associated with the default capability value set is scheduled/used/assumed.

For example, if the terminal device 220 reports two capability values sets, i.e., capability value set #1 corresponding to maximum 2-layer PUSCH and capability value set #2 corresponding to maximum 4-layer PUSCH. If the capability value set with a lower capability is assumed as the default capability value set. During the initial transmission, the network device 210 should not schedule PUSCH transmission with number of layers more than the lower reported value (i.e., 2-layer), while the terminal device 220 does not expect (or, is not expected) to transmit more than 2-layer PUSCH.

Additionally, in some embodiments, during the initial transmission, the uplink transmission/scheduling may be performed with a spatial domain transmission filter associated with an assumed RS, where the assumed RS should be associated with the default capability value set. In other words, the uplink transmit beam for SRS/PUCCH/PUSCH should be associated with the default capability value set.

Examples of the assumed RS include the latest PRACH beam/RS, the RS/beam used for initial access and so on.

In this way, the original transmission between the terminal device 220 and the network device 210 is well handled.

### Example Processes for Obtaining the Correspondence Report

The terminal device 220 may measure the signal quality of the RS, such as, RSRP, SINR, coupling loss, path loss, UL transmit power and so on, which may be configured by the network device 210 or up to an UE implementation. Then, the terminal device 220 may comprise such measurement results in the correspondence report. In order to select a more suitable panel/capability value set and avoid the out-of-date issue of the correspondence report, the configuration about time restriction may be introduced for obtaining the measurements result/correspondence report.

As discussed previously, the capability-related information and configuration about the time restriction may be exchanged between the terminal device 220 and the network device 210.

Specifically, the network device 210 may transmit the information about a time restriction for obtaining the correspondence report to the terminal device 220. In one example embodiment, the time restriction can be configured by a newly introduced higher layer parameter (be represented as timeRestrictionForPanelCorrespondence). Alternatively, in another example embodiment, the time restriction can be configured by re-using a legacy parameter (such as, timeRestrictionForChannelMeasurements, timeRestrictionForInterferenceMeasurements). In some embodiments, the terminal device 220 may report whether time restriction is applied when obtaining the correspondence report. Specifically, one additional bit may be comprised in correspondence report may to indicate whether time restriction is applied when obtaining the correspondence report/whether the reported correspondence report is obtained based on the time restriction.

With the information about the time restriction configured by the network device 210, the terminal device 220 may obtain the correspondence report accordingly. Specifically, if the terminal device 220 is not configured with time restriction, the terminal device 220 shall obtain/derive the correspondence report by measuring multiple RSs (such as, the CSI-RS or SSB). Correspondingly, if the terminal device 220 is configured with time restriction, the terminal device 220 shall obtain/derive the correspondence report by measuring merely the last RS (the most recent CSI-RS or SSB). Additionally, the RS(s) used to obtain/derive the correspondence report should be no later than a reference resource.

In some embodiments, the reference resource is the RS transmitted at transmission occasion (be represented as Pf). In some embodiments, Pf=Pn−Tref, where Tref is pre-defined or configured by the network device 210 and can have different values depending on downlink or uplink numerologies, carrier aggregation configurations, time domain behavior configuration, time restriction configurations and so on.

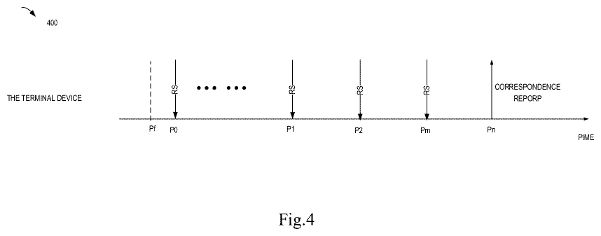

Reference is now made to FIG. 4, which illustrates an interaction timing 400 according to some embodiments of the present disclosure. As can be illustrated in FIG. 4, before the transmission occasion for transmitting the correspondence report (i.e, Pn), there are a plurality of transmission occasions for receiving the RSs before the reference resource (i.e., Pf as illustrated in FIG. 4). If the terminal device 220 is not configured with time restriction, the terminal device 220 may obtain/derive the correspondence report based on multiple RSs (i.e., RSs transmitted at least part of the transmission occasions P0˜Pm). Correspondingly, if the terminal device 220 is configured with time restriction, the terminal device 220 may obtain/derive the correspondence report by measuring merely the last RS (i.e., RS transmitted at the transmission occasion Pm).

In some embodiments, when measuring the signal quality, the terminal device 220 may apply two capability value sets (i.e., the currently-used capability value set and a new capability value set) and determine whether to report the correspondence report associated with a new capability value set based on the measured results.

In one specific example embodiments, the terminal device 220 is currently applying the one or more capability value sets (referred to as old capability value set) and expects to switch to one or more other capability value sets (referred to as new capability value set). When measuring the RS(s), the terminal device 220 may activate/apply both the old and new capability value sets. Next, the terminal device 220 compare measurement results on both the old and new capability value sets to decide whether it will report a correspondence associated with the new capability value sets.

Alternatively, the terminal device 220 may apply the new capability value sets when measuring the RS(s). In this event, the terminal device 220 compares the measurement result with the previous measurement results associated with the old capability value sets.

Additionally, the comparison of the measurement results may be implemented based on a criterion associated with RSRP, SINR, coupling loss, path loss, unlink transmit power and so on.

### Example Processes for Generating and Indexing the Correspondence Report

As discussed above, the terminal device 220 may transmit the correspondence report to the network device 210. According to some embodiments of the present disclosure, the correspondence report may comprise more fields and indicates more information. Further, the identity information may be re-defined, such that new state of the capability value set may be introduced. In the following text, more details about the correspondence report will be discussed.

In some embodiments, the correspondence report comprises identity information for each of the capability value set indicated in the correspondence report.

As discussed above, each capability value set may corresponded to a panel (a physical entity) deployed at a terminal device, a specific panel type and a state of the capability value set. When reporting the capability-related information, the capability value set may be indexes by the identity information, where the identity information may be an index of a capability value set, an index of a panel deployed at the terminal device 220 or a state of the capability value set. The indexing mechanism used for reporting the capability-related information as discussed above also may be used when reporting the correspondence report. For brevity, the similar contents are omitted and some additional features will be discussed below.

Additionally, the state of capability value set may have a more diversified definition. Specifically, the state of capability value set may indicate that a capability value set is used for uplink or a capability value set is used for downlink. Additionally, the state of capability value set may indicate some reserved states, such an application state of a capability value set indicating whether the capability value set has been applied or is to be applied. Alternatively, or in addition, in some embodiments, the state of capability value set may indicate whether the applied capability value set has been changed or is to be changed. In one specific example embodiment, the state of capability value set may indicate one of the following: the capability value set being used for uplink, the capability value set being used for downlink (i.e., only for downlink panel/not related to uplink panel), the capability value set being not suitable for uplink transmission (such as, the terminal device 220 cannot use the reported beam for uplink transmission), whether the (activated/applied) uplink capability value set/panel has been changed, or whether the (activated/applied) uplink capability value set/panel is going to be changed, the applied capability value set having been changed or is to be changed and so on.

In summary, a panel information field (i.e., the identity information) may be comprised in the correspondence report may comprise, and further some values of the panel information field may be reserved and used for indicating the newly-defined/introduced downlink only state and the some reserved states.

Additionally, the bit size of the panel information field comprised in the correspondence report also may be determined based on at least one of: the number of the capability value sets, the number of panels deployed at the terminal device 220, the number of the states of the capability value set. In one specific example embodiment, the bit size of the panel information field is determined based on either or both of the number of reserved status and number of capability value sets.

Additionally, the reserved states may be selectable reported and configured. Specifically, the terminal device 220 may report which reserved states are supported by the terminal device 220. Correspondingly, the network device 210 may enable/disable part of the reserved states.

In some embodiments, the reserved status may be represented in ascending/descending order.

In some embodiments, a number of capability value sets associated with one correspondence report may be configured. In one specific example embodiment, one correspondence report is associated with one capability value set. Alternatively, the one correspondence report is associated with more than one capability value set.

In some embodiments, the number of RSs/beams associated with one capability value set also may be configured. In one specific example embodiment, in the correspondence report, each RSs/beams corresponds to one capability value set.

In summary, the terminal device 220 may generate the correspondence report with a suitable format. Below table 2 illustrates four possible formats of the correspondence report.

TABLE 2
illustrates four possible formats of the correspondence report

| Format #1 | Format #2 | Format #3 | Format #4 |
|---|---|---|---|
| 1^{st} Panel info | 1^{st} Panel info | Panel info | 1^{st} Panel info |
| 1^{st} SSBRI/CRI | 2^{nd} Panel info | 1^{st} SSBRI/CRI | 2^{nd} Panel info |
| 1^{st} RSRP/SINR | . . . | 2^{nd} SSBRI/CRI | 1^{st} SSBRI/CRI |
| 2^{nd} Panel info | 1^{st} SSBRI/CRI | . . . | 2^{nd} SSBRI/CRI |
| 2^{nd} SSBRI/CRI | 2^{nd} SSBRI/CRI | N^{th} SSBRI/CRI | . . . |
| 2^{nd} RSRP/SINR | . . . | 1^{st} RSRP/SINR | 1^{st} RSRP/SINR |
| . . . | 1^{st} RSRP/SINR | 2^{nd} RSRP/SINR | 2^{nd} RSRP/SINR |
| N^{th} Panel info | 2^{nd} RSRP/SINR | . . . | . . . |
| N^{th} SSBRI/CRI | . . . | N^{th} RSRP/SINR | |
| N^{th} RSRP/SINR | | | |

In the above table 2, “Panel info” refers to the identity information of the capability value set, “SSBRI/CRI” refers to the information of a RS/beam, and “RSRP/SINR” refers to the measurement result of the corresponding RS/beam. In addition, or alternatively, 1^{st} RSRP/SINR is a 7-bit value, and each of the remaining RSRP/SINR is represented with a 4-bit differential RSRP/SINR value computed with a reference to the 1^{st} RSRP/SINR.

In some embodiments, one capability value set corresponds to one RS/beam (i.e., one panel per SSBRI/CRI), as can be seen from above Format 1/2. By using Format 1/2, the terminal device 220 may report different choices of uplink RSs/beams for different panels.

In some embodiments, one correspondence report corresponds to one capability value set, as can be seen from Format 3. By using Format 3, the terminal device 220 indicates that all the reported SSBRI/CRI (i.e., RSs/beams) can be used as an uplink RS/beam when the terminal device 220 uses this panel for an uplink transmission.

In some embodiments, the network device 210 may configure the number of capability value sets (be represented as “X”, where X<number of capability value sets configured to be reported) comprised in a correspondence report. For each reported capability value set, one or more RSs/beams may be reported. Additionally, the remaining RSs/beams may be used for downlink. The above Format 4 illustrates that the number of capability value sets comprised in one correspondence report is “2”.

In some embodiments, the content or format of correspondence report may be determined based on a time restriction configuration. Specifically, if the time restriction is applied, only the most recent RS can be used for obtaining the correspondence report, especially for the terminal device 220 which cannot support simultaneous multiple active panels, only one panel can be used to obtain/derive the correspondence report. In one specific example embodiment, the terminal device 220 transmits the correspondence report with one capability value set index regardless of the configured number of capability value set indexes if the time restriction is applied when obtaining the correspondence report. In another specific example embodiment, the terminal device 220 transmits the correspondence report which corresponds to one capability value set (e.g., Format 3) if the time restriction is applied, and the terminal device 220 transmits the correspondence report in which one capability value set corresponds to one RS/beam (e.g., Format 1/2) or in which the configured number of capability value sets is comprised (e.g., Format 4) if the time restriction is not applied.

In addition to the above, the network device 210 may transmit a configuration indicating the RS resource to the terminal device 220 with information element (IE) of “RS resource set”. Further, one parameter of “repetition” may be comprised in the IE of “RS resource set”. In case that the parameter of “repetition” is enabled (i.e., a value of the parameter of repetition is “on”), the network work device 210 transmits all of the CSI-RS resources with a same Tx beam. In other words, there is only one beam for downlink transmission and the information of the one beam is known to the network device 210. In this event, it is unnecessary to report the RS/beam information to the network device 210. Thus, some further improvements may be performed either by the network device 210 or the terminal device 220.

In some embodiments, the terminal device 220 is not expected to be configured to report the correspondence report if the parameter of “repetition” comprised in an RS resource set is enabled/“on”. For example, the parameter “report quantity” comprised in the configuration is used to indicate the terminal device 220 to report the correspondence report comprising identity information of the capability value set. In this event, parameters “report quantity” indicating to report the identity information of the capability value set and “repetition” set as “on” will not be enabled/configured to the terminal device 220 simultaneously.

According to some embodiments of the present disclosure, even if the terminal device 220 is configured to report the correspondence report when the parameter of “repetition” comprised in an RS resource set is enabled/“on”, the terminal device 220 still can well handle such scenario as discussed below.

In some embodiments, in case that the value of a parameter of repetition comprised in an RS resource set is “on”, the terminal device 220 disables reporting the correspondence report.

Alternatively, or in addition, in some embodiments, in case that the value of a parameter of repetition comprised in an RS resource set is “on”, the terminal device 220 transmits the correspondence report associated with one RS.

Alternatively, or in addition, in some embodiments, tin case that the value of a parameter of repetition comprised in an RS resource set is “on”, the terminal device 220 transmits the correspondence report with one capability value set index regardless of the configured number of capability value set indexes.

Alternatively, or in addition, in some embodiments, in case that the value of a parameter of repetition comprised in an RS resource set is “on”, the terminal device 220 transmits the correspondence report without comprising information about an RS.

Further, the correspondence report may comprise further information/field. In some embodiments, the terminal device 220 may indicate whether the correspondence is obtained based on the time restriction. In one specific example embodiment, correspondence report comprise an indication with one bit, where in the indication indicates whether the correspondence report is determined based on only the most recent downlink RS.

Then the terminal device 220 may generate the correspondence report and transmits 340 the correspondence report to the network device 210.

### Example Processes for the Feedback Mechanism

As discussed previously, the correspondence report may cause a change/switch of the panel/beam/RS/capability value set. Thus, the transmission state of the correspondence report should be aligned between the network device 210 and the terminal device 220. As a result, a feedback mechanism for the correspondence report is needed.

According to some embodiment of the present disclosure, the terminal device 220 and the network device 210 communicate 350 with each other according to a feedback state of the correspondence report, where, the feedback state may be ACK or NACK. Alternatively, the feedback state may be ACK, NACK, or “not transmitted/detected” (i.e., no ACK/NACK). It should be understood that, when the feedback mechanism for the correspondence report is introduced, no ACK/NACK should be interpreted as “NACK”.

In order to avoid introducing any new message/signalling (including a new radio network temporary identifier, RNTI, or a new downlink control information, DCI, for the feedback for the correspondence report), some existing message/signaling may be used to indicate the feedback state (referred to as feedback message hereafter).

One example of the feedback message is a TCI activation command or a TCI indication. Specifically, in case that the TCI activation command or the TCI indication comprises information about TCI state(s) which is at least partially associated with the at least one RS indicated by the correspondence report, the feedback state of the correspondence report is ACK. Correspondingly, if the TCI activation command or the TCI indication comprises information about TCI state(s) which is irrelevant with the RS(s) indicated by the correspondence report, the feedback state of the correspondence report is NACK. Alternatively, if the TCI activation command or the TCI indication comprises information about TCI state(s) which is associated to at least one RS with more ports than the maximum SRS ports of the capability value set(s) in the correspondence report, the feedback state of the correspondence report is NACK. In addition, the TCI activation command or the TCI indication is the first one received right after the transmission of correspondence report. Alternatively, the TCI activation command or the TCI indication is the first one received within a certain time period after the transmission of the correspondence report. In some embodiments, the TCI activation command or the TCI indication is carried via MAC CE signaling or DCI. In some embodiments, the TCI activation command or the TCI indication comprises joint TCI state(s) for both uplink and downlink, or uplink only TCI state(s). In some embodiments, the TCI activation command or TCI indication comprises TCI states applied for all physical channels/signals including PDCCH, PDSCH, PUCCH, PUSCH, or only applied for a subset of physical channels/signals such as PUSCH.

Another example of the feedback message is a DCI message for scheduling PUSCH and comprising a SRS resource indicator (SRI). In some embodiments, in case that the SRI points to SRS resources with more ports than the maximum SRS ports associated with the capability value set(s) in the correspondence report, the feedback state of the correspondence report is NACK, otherwise, the feedback state is ACK. In some other embodiments, in case that the SRI points to SRS resources with the number of ports not matched with maximum SRS ports associated with the capability value set(s) in the correspondence report, the feedback state of the correspondence report is NACK, otherwise, the feedback state is ACK.

Another example of the feedback message is a DCI message for scheduling PUSCH and comprising a transmit precoding matrix indicator (TPMI) in DCI for scheduling PUSCH. In some embodiments, in case that the TPMI indicates a larger number of layers than the number of the maximum SRS ports associated with the capability value set(s) in the correspondence report, the feedback state of the correspondence report is NACK, otherwise, the feedback state is ACK. In addition, the DCI for scheduling PUSCH is the first one received right after the transmission of correspondence report. Alternatively, the DCI for scheduling PUSCH is the first one received within a certain time period after the transmission of the correspondence report.

Another example of the feedback message is a PDCCH order to trigger a RA/RACH procedure. Specifically, a RA procedure may be used for timing alignment of the capability value set/panel associated with the reported correspondence report, and thus the PDCCH order may be used to indicate that the state of the correspondence report is ACK. In addition, the terminal device 220 transmits a RACH with the reported panel in the correspondence report after receiving the PDCCH order. In addition, the PDCCH order is the first one received right after the transmission of correspondence report. Alternatively, the PDCCH order is the first one received within a certain time period after the transmission of the correspondence report.

A further example of the feedback message is a signaling for controlling the transmit power of the terminal device 220. Specifically, a signaling for controlling the transmit power may be used to indicate that the state of the correspondence report is ACK. In one specific example embodiment, the signaling for controlling the transmit power comprises a transmit power control (TPC) field for TPC for SRS/PUCCH/PUSCH trigger a power adjustments for the panel/capability value set associated with the correspondence report. Additionally, in some embodiments, the signaling for controlling the transmit power is a DCI message with format 2-2 or 2-3 for TPC without uplink grant. In addition, the signaling for controlling the transmit power is the first one received right after the transmission of correspondence report. Alternatively, the signaling for controlling the transmit power is the first one received a certain time period after the transmission of the correspondence report.

A further example of the feedback message is a message to trigger the terminal device 220 to report a correspondence report. In one specific example embodiment, message used for triggering activating an aperiodic or semi-persistent correspondence report is used to indicate that the state of the correspondence report is NACK. For example, a periodic correspondence reported is configured, while the network device 210 fails to receive the expected periodic correspondence report. Therefore, the network device 210 may transmit a message to trigger the terminal device 220 to report an aperiodic or semi-persistent correspondence report. Thus, the message implies a failure transmission of a periodic correspondence report which indicates a NACK state.

A further example of the feedback message is a message for activating a SRS transmission. Specifically, an aperiodic or semi-persistent SRS transmission associated with the capability value set may be used for training the uplink codebook, precoder used for non-codebook-based uplink transmission or uplink beam for capability value set associated with the correspondence report. In some embodiments, the SRS transmissions can be the SRS resource set/resource/ports associated with the corresponding capability value set as indicated in Table 1. Thus, the message for activating a SRS transmission may be used for indicating an ACK state.

A further example of the feedback message is a message for activating a CSI report transmission. Specifically, an aperiodic or semi-persistent CSI report may be used for training the downlink receiving beam associated with capability value set. Additionally, the triggered/activated CSI report may be configured to disable reporting the identity information of the capability value set (i.e., the parameter of “report quantity” is configured to be “none”) and the parameter of repetition in the resource set is configured to be “on”. In some embodiments, the CSI report transmissions can be based on downlink RS resources associated with the corresponding capability value set as indicated in Table 1.

In order to reducing signalling overhead, the correspondence report may be transmitted/received conditionally. In other words, in some scenarios, the terminal device 220 does not expect to receive the feedback message while the network device 210 also does not transmit the feedback message.

In some embodiments, the feedback message is only transmitted/received when the correspondence report to be reported is at least partially different from the previous correspondence report. In other words, the correspondence report to be reported may update the previous correspondence report.

In one specific example embodiment, a correspondence report indicating a correspondence between at least one first capability value set and at least one first RS is to be reported from the terminal device 220 to the network device 210. In some embodiments, the feedback message is transmitted/received in case that the at least one correspondence is at least partially different from a second correspondence, where the second correspondence is currently applied at the terminal device 220 or is associated with the latest correspondence report.

Alternatively, or in addition, in some other embodiments, the feedback message is transmitted/received in case that the at least one first capability value set associated with the correspondence report is at least partially different from the at least one second capability value set, where the at least one second capability value set is currently applied at the terminal device 220 or is associated with the latest correspondence report.

Alternatively, or in addition, in some other embodiments, the feedback message is transmitted/received in case that the at least one first RS associated with the correspondence report is at least partially different from the at least one second RS, where the at least one second RS is currently used at the terminal device 220 or is associated with the latest correspondence report.

Further, more than one second correspondence report may be considered when determining whether to transmit/receive the feedback message. In this event, the second correspondence report(s) may refer to one or more correspondence reports that transmitted within a certain time duration.

Alternatively, or in addition, in some other embodiments, the feedback message is transmitted/received in case that the correspondence report is configured with a specific time domain behavior. In other words, the feedback message is not transmitted/received in case that the correspondence report is configured with a specific time domain behavior. In particular, periodic feedback is not preferred due to the larger signaling overhead it may cause. In some embodiments, the feedback message is not transmitted/received in case that the correspondence report is periodic. In some embodiments, the feedback message is not transmitted/received for the periodic correspondence report in case that both periodic correspondence report and aperiodic/semi-persistent correspondence report are configured.

In some embodiments, an updating/overriding rule may be defined when determining whether to transmit/receive the feedback message.

In one specific example embodiment, the comparison between the correspondence report and the at least one second correspondence report (for example, the currently-applied correspondence report, the latest correspondence report, or the correspondence report(s) transmitted within a certain time duration) is performed only in case that the correspondence report and the at least one second correspondence report are configured with a same time-domain behavior (such as, periodic, a periodic and semi-persistent).

Alternatively, or in addition, in another specific example embodiment, whether to transmit/receive the feedback message may be determined based on a priority order of time-domain behavior. One example of the priority order is an aperiodic time domain behavior, a semi-persistent time domain behavior/a periodic time domain behavior. Another example of the priority order is a periodic time domain behavior, an aperiodic time domain behavior/a semi-persistent time domain behavior. A further example of the priority order is an aperiodic time domain behavior, a semi-persistent time domain behavior and a periodic time domain behavior. A further example of the priority order is a periodic time domain behavior, an aperiodic time domain behavior, and a semi-persistent time domain behavior. It is to be understood that in other example embodiments, other priority orders may be applied.

Alternatively, or in addition, in some other embodiments, whether to transmit/receive the feedback message is determined based on the identity information of a capability value set associated with the correspondence report. Specifically, the feedback message is transmitted/received in case that the identity information indicates a specific state of capability value set. In one specific example embodiment, the feedback message is transmitted/received in case that the identity information indicates the capability value set being used for uplink. Alternatively, in another specific example embodiment, the feedback message is transmitted/received in case that the identity information indicates the capability value set being not used for downlink. Alternatively, in another specific example embodiment, the feedback message is transmitted/received in case that the identity information indicates a non-reserved state.

In some embodiments, the message is transmitted/received within a certain time period after correspondence report. In other words, if the terminal device 220 fails to receive a feedback message within a certain period after transmitting the correspondence report, the terminal device 220 determines the feedback state to be NACK.

In this way, the signalling overhead caused by the feedback mechanism is minimized.

In addition to the above, the operation on the newly-reported capability value set(s) should be aligned at both the terminal device 220 and the network device 210.

In some embodiments, the operation of applying the newly-reported capability value set is controlled by the network device 210.

In one specific example embodiment, the newly-reported capability value set is applied in response to a transmission of the feedback message for the correspondence report.

Alternatively, in another specific example embodiment, the newly-reported capability value set is applied in response to a SRS transmission from the terminal device 220 to the network device 210 after receiving the feedback message.

Alternatively, in some embodiments, the operation on the newly-reported capability value set(s) is controlled by the terminal device 220.

In one specific example embodiment, the newly-reported capability value set is applied in response to a transmitting of the correspondence report.

Alternatively, in another specific example embodiment, the newly-reported capability value set is applied in response to a period since transmitting the correspondence report exceeding a pre-configured period.

Additionally, in some embodiments, if there are a plurality of RSs indicated by the first correspondence, the terminal device 220 transmits an uplink transmission with a spatial domain transmission filter associated with an RS of the plurality of RSs with a best signal quality.

Additionally, in case that the operation of applying the newly-reported capability value set is controlled by the terminal device 220 and a failure transmission of the correspondence report occurs, the terminal device 220 should fall back to the previous operation state. Specifically, if the terminal device 220 fails to receive a feedback message indicating an ACK for or receives a feedback message indicating a NACK for the correspondence report, the terminal device 220 disables applying the newly-reported capability value set.

In addition to the above, the operation on the currently-used capability value set(s) (referred to as the second capability value set(s)) also should be aligned at both the terminal device 220 and the network device 210.

In some embodiments, the second capability value set(s) is continued to be applied after transmitting the correspondence report for a certain period.

Alternatively, in some other embodiments, the second capability value set(s) is continued to be applied until receiving a message indicating an ACK for the correspondence report from the network device 210.

Alternatively, in some other embodiments, the second capability value set(s) is continued to be applied until receiving a message indicating an ACK for the correspondence report from the network device 210.

Alternatively, in some other embodiments, the second capability value set(s) is continued to be applied until next transmission occasion for the correspondence report. In other words, the second capability value set(s) is continued to be applied until transmitting a further correspondence report to the network device 210.

Additionally, the transmit power of the terminal device 220 is controlled by the network device 210. Specifically, the transmit power of the terminal device 220 may be operated under an accumulation mode, where the terminal device 220 maintains an accumulation power control adjustment state and adjust the transmit power according to the TPC command from the network device 210.

According to some embodiments of the present discourse, the terminal device 220 will reset the accumulation of power control adjustment state in response to applying the newly-reported correspondence.

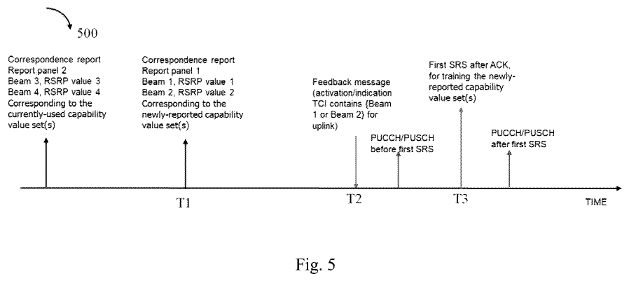

For better understanding, some example operations are discussed with reference to the below two specific embodiments and FIG. 5, where FIG. 5 illustrates an interaction timing 500 according to some embodiments of the present disclosure.

Some Example Operations with Regards to One Specific Example Embodiment

In this specific example embodiment, the operation of applying the newly-reported capability value set is controlled by the network device 210.

As illustrated in FIG. 5, at the beginning, the terminal device 220 and the network device 210 applies the second capability value set(s). Next, the terminal device 220 transmits a correspondence report to the network device 210 at time point T1 and receives the feedback message at time point T2. Further, time point T3 refers to the first transmission occasion for SRS after receiving the feedback message.

In some embodiments, after transmitting the correspondence report to the network device 210 at time point T1, the terminal device 220 keeps the newly-reported activated for a while, such that the terminal device 220 may switch to the newly-reported in time.

In some embodiments, the terminal device 220 keeps the newly-reported activated for a pre-configured certain time duration after transmitting a correspondence report.

Alternatively, in some embodiments, the terminal device 220 keeps the newly-reported activated till the next transmission occasion for the correspondence report, including a periodic correspondence report, an aperiodic correspondence report, or a semi-persistent correspondence report.

Alternatively, in some embodiments, the terminal device 220 keeps the newly-reported activated till the transmission of the feedback message. As illustrated in FIG. 5, the terminal device 220 keeps the newly-reported activated until the time point T2.

In the specific example of FIG. 5, the operation of applying the newly-reported capability value set(s) is controlled by the network device 210.

In some embodiments, the terminal device 220 and the network device 210 apply the newly-reported capability value set(s) after the transmission of the feedback message. As illustrated in FIG. 5, the terminal device 220 and the network device 210 start apply the newly-reported capability value set(s) since the time point T2. Additionally, an offset (such as, an X time unit) may be applied. In other words, the starting time point of applying the newly-reported capability value set(s) is X time units after the time point T2.

In some embodiments, the terminal device 220 will reset the accumulation of power control adjustment state in response to applying the newly-reported capability value set(s). Specifically, upon applying the newly-reported capability value set(s) (i.e., right after an uplink panel switch), the TPC control should not be accumulated regardless of the power configuration. In one specific example embodiment, the terminal device 220 resets accumulation of a PUSCH/PUCCH/SRS power control adjustment state 1 or all states or a subset of states associated with the newly-reported capability value set(s). Optionally, an indication in TPC command filed can stand for an absolute value or an accumulated value. In one specific example embodiment, 0 in TPC command filed can stand for −4 dB as the absolute value and −1 dB as the accumulated value. In another specific example embodiment, the terminal device 220 applies the absolute value(s) according to the indication in TPC command filed, regardless of the power configuration. In other words, the terminal device 220 does not apply the accumulated value(s) according to the indication in TPC command filed, regardless of the power configuration.

The operation on the currently-used second capability value set(s) is discussed as below.

In some embodiments, the terminal device 220 and the network device 210 continue to apply the second capability value set(s) until applying the newly-reported capability value set(s). Additionally, an offset (such as, an X time unit) may be considered.

Further, the SRS is used to train the uplink beam/precoder/codebook associated with the newly-reported capability value set(s). Before obtaining the trained results, the terminal device 220 may not be able to use the newly-reported capability value set(s). Thus, in some embodiments, the terminal device 220 and the network device 210 continue to apply the second capability value set(s) until the first SRS transmission (i.e., time point T3). Alternatively, in some embodiments, after the feedback message received, different panel/beam assumptions are applied for PUCCH/PUSCH transmission before the first SRS transmission (i.e., time point T3).

Additionally, the triggering/activation SRS transmission is conditionally. Specifically, in case that the feedback message indicates a NACK, the terminal device 220 will not triggering/activation SRS transmission (i.e., the triggering/activation SRS transmission at time point T3).

Some Example Operations with Regard to Another Specific Example Embodiment

As illustrated in FIG. 5, at the beginning, the terminal device 220 and the network device 210 applies the second capability value set(s). Next, the terminal device 220 transmits a correspondence report to the network device 210 at time point T1 and receive the feedback message at time point T2.

In some embodiments, the terminal device 220 receives the feedback message by using a downlink panel corresponding to the newly-reported capability value set(s). In case that the feedback message is a TCI activation command, the terminal device 220 will apply the reported capability value set(s) by using the indicated TCI.

In this specific example embodiment, the operation of applying the newly-reported capability value set is controlled by the terminal device 220, which means that the newly-reported capability value set is applied before the time point T2.

Further, the terminal device 220 may report the RS/beam information (such as, reported SSBRI/CRI for uplink transmission) in order to apply the newly-reported capability value set.

Alternatively, an assumed RS/beam may be used when applying the newly-reported capability value set. In one specific example embodiment, if more than one SSBRI/CRI are reported (i.e., RS/beam information), some rules for selecting the RS/beam may be pre-defined. For example, stipulate always applying the SSBRI/CRI with the best reported RSRP/SINR.

In some embodiments, the terminal device 220 and the network device 210 apply the newly-reported capability value set(s) upon the transmission of the correspondence report. As illustrated in FIG. 5, the terminal device 220 and the network start apply the newly-reported capability value set(s) since the time point T1. Additionally, an offset (such as, an X time unit) may be applied. In other words, the starting time point of applying the newly-reported capability value set(s) is X time units after the time point T1.

The operation on the currently-used second capability value set(s) is discussed as below.

In some embodiments, the terminal device needs to keep the currently-used second capability value set(s) activated for a while (such as, a pre-defined period).

In some embodiments, the terminal device 220 and the network device 210 continue to apply the second capability value set(s) until applying the newly-reported capability value set(s). Additionally, an offset (such as, an X time unit) may be considered.

Further, the power control operation is performed at the terminal device 220. Specifically, the terminal device 220 will reset the accumulation of power control adjustment state in response to applying the newly-reported capability value set(s). Specifically, upon applying the newly-reported capability value set(s) (i.e., right after an uplink panel switch), the TPC control should not be accumulated regardless of the power configuration. In one specific example embodiment, the terminal device 220 resets accumulation of a PUSCH/PUCCH/SRS power control adjustment state 1 or all states or a subset of states associated with the newly-reported capability value set(s).

Additionally, as discussed above, if the terminal device 220 fails to receive a feedback message indicating an ACK for or receives a feedback message indicating a NACK for the correspondence report, the terminal device 220 disables applying the newly-reported capability value set(s). In this event, the TPC command should not be accumulated by the terminal device 220.

Optionally, an indication in TPC command filed can stand for an absolute value or an accumulated value. In one specific example embodiment, 0 in TPC command filed can stand for −4 dB as the absolute value and −1 dB as the accumulated value. In another specific example embodiment, the terminal device 220 applies the absolute value(s) according to the indication in TPC command filed, regardless of the power configuration. In other words, the terminal device 220 does not apply the accumulated value(s) according to the indication in TPC command filed, regardless of the power configuration.

### Example Processes for Falling Back Mechanism

As discussed above, after transmitting the correspondence report, under some specific scenario, the terminal device 220 and the network device 210 may need to communicate with each other by using a default capability value set.

Still refers to FIG. 3, if a fallback condition meets, the terminal device 220 and the network device 210 fall 360 back to apply the default capability value set.

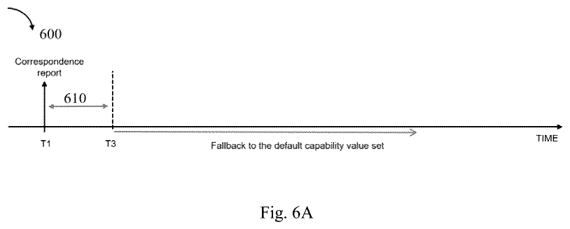

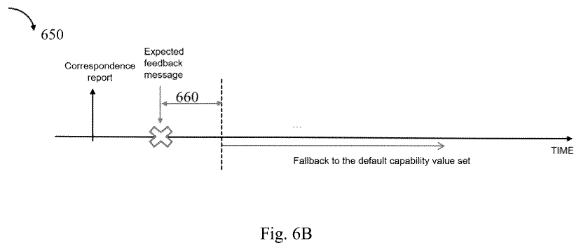

Some detailed operations are described with references to FIGS. 6A and 6B. In the specific examples of FIGS. 6A and 6B, T1 refers to the time point for transmitting the correspondence report, while T2 refers to the expected time point for receiving the feedback message for the correspondence report. It is to be understood that the falling back operation does not depend on the feedback mechanism discussed above.

According to the present disclosure, the time point for applying the default capability value set may be defined by any suitable fallback condition.

In some embodiments, the terminal device 220 determines the fallback condition meets if a period since transmitting the correspondence report exceeds a pre-defined period. In other words, the terminal device 220 and the network device 210 falls back to apply the default capability value set after the terminal device 220 transmitting the correspondence report for a certain period (duration 610 as illustrated in FIG. 6B). As illustrated in FIG. 6A, the terminal device 220 and the network device 210 falls back to apply the default capability value set at time point T3. As can be seen, the implementation of this embodiment is independently from the feedback mechanism.

Alternatively, in some embodiments, the terminal device 220 determines the fallback condition meets if the terminal device 220 fails to receive a message indicating an ACK for the correspondence report after transmitting the correspondence report for a certain duration.

Alternatively, in some embodiments, the terminal device 220 determines the fallback condition meets if the terminal device 220 fails to receive a message indicating an ACK for the correspondence report at a transmission occasion for receiving the message after transmitting the correspondence report for a certain duration (duration 660 as illustrated in FIG. 6B). As illustrated in FIG. 6B, the terminal device 220 and the network device 210 falls back to apply the default capability value set at time point T4.

Alternatively, in some embodiments, the terminal device 220 determines the fallback condition meets if the terminal device 220 receives a message indicating a NACK for the correspondence report.

Alternatively, in some embodiments, the terminal device 220 determines the fallback condition meets if the capability value set associated with the correspondence report is configure with a higher capability.

Alternatively, in some embodiments, the terminal device 220 determines the fallback condition meets if the correspondence report is aperiodic.

Alternatively, in some embodiments, the terminal device 220 determines the fallback condition meets if a switch of BWP, a switch of CC, an activation of secondary cell and a cross cell scheduling occurs.

Alternatively, in some embodiments, the terminal device 220 determines the fallback condition meets if the terminal device 220 is operated in a power saving mode (such as, a DRX mode).

Alternatively, in some embodiments, the terminal device 220 determines the fallback condition meets if a new capability value set/RS/beam is reported by the correspondence report.

It should be understood that the above example for determining whether the fallback condition meets can be used either separately or in combination. Further, in some other embodiments, any suitable rules and factors may be used for determining whether the fallback condition meets.

In addition, the definition of the default capability value set (i.e., which capability value set may be used as the default capability value set) is the same with that discussed with regards to the initial transmission in this disclosure. Merely for brevity, the some contents are omitted here.

### Example Methods

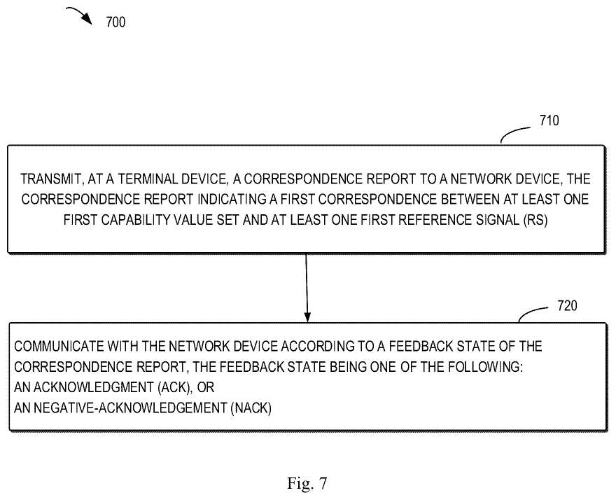

FIG. 7 illustrates a flowchart of an example method 700 in accordance with some embodiments of the present disclosure. For example, the method 700 can be implemented at the terminal device 220 as shown in FIG. 2.

At block 710, the terminal device 220 transmits a correspondence report to a network device 210, the correspondence report indicating a first correspondence between at least one first capability value set and at least one first RS.

At block 720, the terminal device 220 communicates with the network device 210 according to a feedback state of the correspondence report, the feedback state being one of the following: an ACK, or a NACK.

In some embodiments, the terminal device 220 receives a message from the network device 210. The message indicates the feedback state of the correspondence report and is at least one of the following: a TCI activation command at least partially associated with the at least one RS indicated by the correspondence report, a PDCCH order to trigger a RA procedure, a signaling for controlling the transmit power of the terminal device 220, a message to trigger the terminal device 220 to report a correspondence report, a message for activating a SRS transmission, a message for activating a CSI report transmission.

In some embodiments, the terminal device 220 expects to receive the message indicating the feedback state of the correspondence report if at least one of the follow: the at least one first correspondence between at least one first capability value set and at least one first RS associated with the correspondence report is at least partially different from at least one second correspondence applied at the terminal device 220; the at least one first correspondence between at least one first capability value set and at least one first RS associated with the correspondence report is at least partially different from at least one second correspondence associated with the latest correspondence report; the at least one first capability value set associated with the correspondence report is at least partially different from at least one second capability value set currently applied at the terminal device 220; the at least one first RS associated with the correspondence report is at least partially different from at least one second RS applied at the terminal device 220; the correspondence report is configured with a specific time domain behavior, or identity information of a capability value set of the at least one capability value set indicates a specific state of capability value set.

In some embodiments, the state of capability value set is one of the following: a capability value set being used for uplink, a capability value set being used for downlink, or an application state of a capability value set indicating whether the capability value set has been applied or is to be applied.

In some embodiments, the terminal device 220 determines the feedback state of the correspondence report to be NACK in response to: failing to receive a message indicating the feedback state of the correspondence report within a certain period after transmitting the correspondence report; or receiving a message to trigger the terminal device 220 to report an aperiodic or semi-persistent correspondence report after transmitting the correspondence report.

In some embodiments, the terminal device 220 applies the at least one first capability value set associated with the first correspondence in response to one of the following: receiving, from the network device 210, a message indicating an ACK for the correspondence report, or transmitting a SRS after receiving the message indicating the ACK from the network device 210.

In some embodiments, the terminal device 220 applies the at least one first capability value set associated with the first correspondence in response to one of the following: transmitting the correspondence report; or a period since transmitting the correspondence report exceeding a pre-configured period.

In some embodiments, if there are a plurality of RSs indicated by the first correspondence, the terminal device 220 transmits an uplink transmission with a spatial domain transmission filter associated with an RS of the plurality of RSs with a best signal quality.

In some embodiments, the terminal device 220 disables applying the at least one first capability value set associated with the first correspondence if fail to receive a message indicating the feedback state of the correspondence report within a certain period after transmitting the correspondence report; or receive a message indicating a NACK for the correspondence report.

In some embodiments, the terminal device 220 is communicating with the network device 210 by applying at least one second capability value set associated with a second correspondence, and continues to apply the at least one second capability value set associated with the second correspondence after transmitting the correspondence report for a certain period.

In some embodiments, the terminal device 220 is communicating with the network device 210 by applying at least one second capability value set associated with a second correspondence, and continues to apply the at least one second capability value set associated with the second correspondence after transmitting the correspondence report until one of the following: receiving a message indicating an ACK for the correspondence report from the network device 210, or transmitting a further correspondence report to the network device 210 after transmitting the correspondence report.

In some embodiments, the terminal device 220 resets an accumulation of power control adjustment state in response to applying the first correspondence.

In some embodiments, the terminal device 220 generates the correspondence report based on a parameter of time restriction configured by the network device 210 for obtaining the first correspondence.

In some embodiments, the correspondence report further indicates identity information for each of the capability value set indicated in the correspondence report.

In some embodiments, the identity information indicates at least one of the following: an index of a capability value set, an index of a panel deployed at the terminal device 220 and associated with the capability value set, or a state of the capability value set.

In some embodiments, a bit size of the identity information is determined based on at least one of the following: a first number of capability value sets supported by the terminal device 220, or a second number of the states of the capability value set supported by the terminal device 220.

In some embodiments, the terminal device 220 transmits capability-related information of the terminal device 220 to the network device 210. The capability-related information indicates a plurality of capability value sets, a capability value set of the plurality of capability value sets comprising at least one of the following: identity information of the capability value set, a maximum number of sounding reference signal SRS ports, a coherent type, a maximum number of uplink layers, a maximum number of downlink layers, a maximum number of RS ports, a maximum number of codewords, or a maximum number of MIMO layers.

In some embodiments, each of the plurality of capability value sets corresponds to a specific type of capability value set, and the capability-related information further indicates at least one of the following: whether a symmetric antenna structure or an asymmetric antenna structure is deployed at the terminal device 220; or a respective number of capability value set corresponding to each specific type of capability value set.

In some embodiments, the capability-related information further indicates an association relationship among the plurality of capability value sets.

In some embodiments, the capability-related information further indicates at least one of the following: whether the terminal device 220 supports to apply more than one capability value set concurrently; or the number of capability value set supported to be concurrently applied by the terminal device 220.

In some embodiments, the capability-related information further indicate at least one of the following: whether the terminal device 220 supports to determine the feedback state of the correspondence report; whether the terminal device 220 supports to report a correspondence report for downlink transmission; whether the terminal device 220 supports to report a state of a capability value set; whether the terminal device 220 supports to obtain the first correspondence with a time restriction; or a number of capability value sets comprised in a correspondence report supported by the terminal device 220.

In some embodiments, the terminal device 220 receives from the network device 210, at least one configuration to be used by the terminal device 220, the at least one configuration indicating at least one of the following: association relationships between at least one transmission parameter and a capability value set, a time domain behavior of the correspondence report, information about a time restriction for obtaining the first correspondence, report quantity, or a number of capability value sets associated with one correspondence report.

In some embodiments, the at least one transmission parameter comprising at least one of the following: a resource for transmitting SRS, a resource for transmitting PUCCH, a transmission configuration indicator state, or a resource for transmitting downlink RS.

In some embodiments, the terminal device 220 performs a SRS transmission based on both of the at least one configuration and one or more capability value sets currently applied at the terminal device 220.

In some embodiments, if a value of a parameter of repetition comprised in an RS resource set is on, the terminal device 220 performs at least of the following: disabling reporting the correspondence report, or transmitting the correspondence report associated with one RS, transmitting the first correspondence report with one capability value set index regardless of the configured number of capability value set indexes; or transmitting the correspondence report without comprising information about an RS.

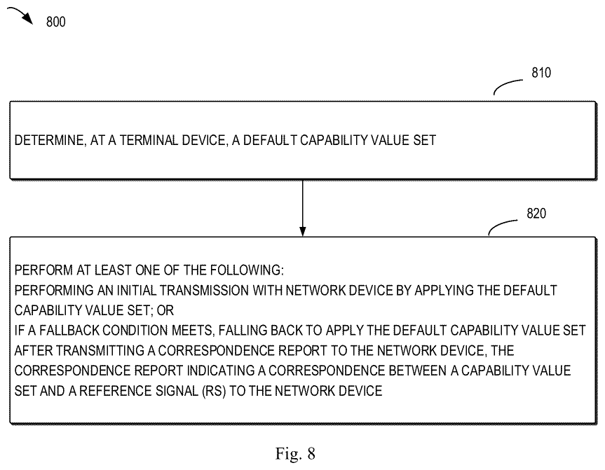

FIG. 8 illustrates a flowchart of an example method 800 in accordance with some embodiments of the present disclosure. For example, the method 800 can be implemented at the terminal device 220 as shown in FIG. 2.

At block 810, terminal device 220 determines a default capability value set.

At block 820, terminal device 220 performs at least one of the following: performing an initial transmission with network device 210 by applying the default capability value set; or if a fallback condition meets, falling back to apply the default capability value set after transmitting a correspondence report to the network device 210, the correspondence report indicating a correspondence between a capability value set and a RS to the network device 210.

In some embodiments, the default value set is one of the following: a capability value set with a lower capability, a capability value set with a higher capability, a capability value set with a lower capability value set index, a capability value set with a higher capability value set index, a last used capability value set, a pre-defined capability value set, a capability value set configured either by the terminal device 220 or the network device 210.

In some embodiments, the terminal device 220 performs the initial transmission during a period between reporting a configuration of at least capability value set and transmitting a first correspondence report.

In some embodiments, the terminal device 220 performs the initial transmission with network device 210 comprising at least one of the following: receiving, from the network device 210, a scheduling message generated according to the default capability value set; or transmitting an uplink transmission with the network device 210 by applying the default capability value set.

In some embodiments, the terminal device 220 transmits information about the default capability value set during a RA procedure.

In some embodiments, the terminal device 220 determines the fallback condition meets if the terminal device 220 fails to receive a message indicating an ACK for the correspondence report after transmitting the correspondence report for a certain duration.

In some embodiments, the terminal device 220 determines the fallback condition meets if the terminal device 220 receives a message indicating an ACK for the correspondence report at a transmission occasion for receiving the message after transmitting the correspondence report for a certain duration.

In some embodiments, the terminal device 220 determines the fallback condition meets if the terminal device 220 receives a message indicating a NACK for the correspondence report.

In some embodiments, the terminal device 220 determines the fallback condition meets if a period since transmitting the correspondence report exceeds a pre-defined period.

In some embodiments, the terminal device 220 determines the fallback condition meets if the capability value set associated with the correspondence report is configure with a higher capability.

In some embodiments, the terminal device 220 determines the fallback condition meets if the correspondence report is aperiodic.

In some embodiments, the terminal device 220 determines the fallback condition meets if a switch of BWP, a switch of CC, an activation of secondary cell or a cross cell scheduling occurs.

In some embodiments, the terminal device 220 determines the fallback condition meets if the terminal device 220 is operated in a DRX mode.

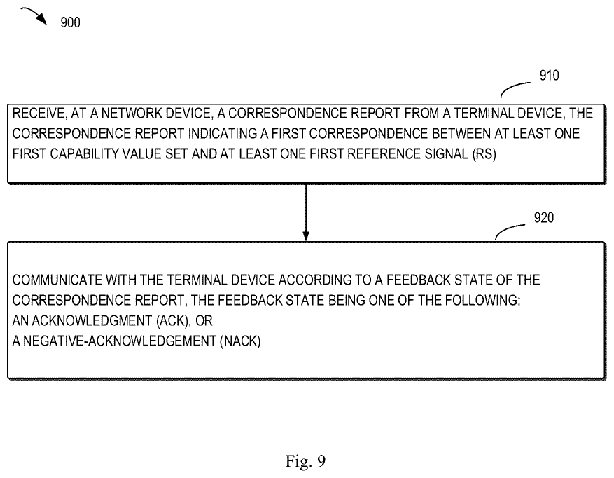

FIG. 9 illustrates a flowchart of an example method 900 in accordance with some embodiments of the present disclosure. For example, the method 900 can be implemented at the network device 210 as shown in FIG. 2.

At block 910, terminal device 220 determines receives a correspondence report from a terminal device 220, the correspondence report indicating a first correspondence between at least one first capability value set and at least one first RS.

At block 920, terminal device 220 communicates with the terminal device 220 according to a feedback state of the correspondence report, the feedback state being one of the following: an ACK, or a NACK.

In some embodiments, the network device 210 transmits a message to the terminal device 220. The message indicates the feedback state of the correspondence report and is at least one of the following: a TCI activation command at least partially associated with the at least one RS indicated by the report, a PDCCH order to trigger a RA procedure, a signaling for controlling the transmit power of the terminal device 220, a message to trigger the terminal device 220 to report a correspondence report, a message for activating a SRS transmission, a message for activating a CSI report transmission.

In some embodiments, the network device 210 transmits the message indicating the feedback state of the correspondence report if at least one of the follow: the at least one first correspondence between at least one first capability value set and at least one first RS associated with the correspondence report is at least partially different from at least one second correspondence applied at the terminal device 220; the at least one first correspondence between at least one first capability value set and at least one first RS associated with the correspondence report is at least partially different from at least one second correspondence associated with the latest correspondence report; the at least one first capability value set associated with the correspondence report is at least partially different from at least one second capability value set currently applied at the terminal device 220; the at least one first RS associated with the correspondence report is at least partially different from at least one second RS applied at the terminal device 220; the correspondence report is configured with a specific time domain behavior, or identity information of a capability value set of the at least one capability value set indicates a specific state of capability value set.

In some embodiments, the state of the capability value set is one of the following: the capability value set being used for uplink, the capability value set being used for downlink, or an application state of a capability value set indicating whether the capability value set has been applied or is to be applied.

In some embodiments, if the network device 210 determines that the feedback state of the correspondence report is NACK, the network device 210 transmits a message to the terminal device 220. The message to trigger the terminal device 220 to report an aperiodic or semi-persistent correspondence report after receiving the correspondence report.

In some embodiments, the network device 210 applies the at least one first capability value set associated with the first correspondence in response to one of the following: transmitting, to the terminal device 220, a message indicating an ACK for the correspondence report, or receiving a SRS after transmitting the message indicating the ACK to the terminal device 220.

In some embodiments, the network device 210 applies the at least one first capability value set associated with the first correspondence in response to one of the following: receiving the correspondence report; or a period since receiving the correspondence report exceeding a pre-configured period.

In some embodiments, if there are a plurality of RSs indicated by the first correspondence, the network device 210 receives an uplink transmission with a spatial domain transmission filter associated with an RS of the plurality of RSs with a best signal quality.

In some embodiments, the network device 210 disables applying the at least one first capability value set associated with the first correspondence in accordance with a determination that the feedback state of the first correspondence report is NACK.

In some embodiments, the network device 210 is communicating with the terminal device 220 by applying the at least one second capability value set associated with a second correspondence and continues to apply the at least one second capability value set associated with the second correspondence after receiving the first correspondence report for a certain period.

In some embodiments, the network device 210 is communicating with the terminal device 220 by applying the at least one second capability value set associated with a second correspondence and continues apply the at least one second capability value set associated with the second correspondence after receiving the first correspondence report until one of the following: transmitting a message indicating an ACK for the correspondence report to the terminal device 220, or receiving a further correspondence report from the terminal device 220 after receiving the correspondence report.

In some embodiments, the correspondence report further indicates identity information for each of the capability value set indicated in the correspondence report.

In some embodiments, the identity information indicates at least one of the following: an index of a capability value set, an index of a panel deployed at the terminal device 220 and associated with the capability value set, or a state of the capability value set.

In some embodiments, a bit size of the identity information is determined based on at least one of the following: a first number of capability value sets supported by the terminal device 220, or a second number of the states of the capability value set supported by the terminal device 220.

In some embodiments, the network device 210 receives capability-related information of the terminal device 220 from the terminal device 220. The capability-related information indicating a plurality of capability value sets, a capability value set of the plurality of capability value sets comprising at least one of the following: identity information of the set of capability parameters, a maximum number of sounding reference signal SRS ports, a coherent type, a maximum number of uplink layers, a maximum number of downlink layers, a maximum number of RS ports, a maximum number of codewords, or a maximum number of MIMO layers.

In some embodiments, each of the plurality of capability value sets corresponds to a specific type of capability value set, and the capability-related information further indicates at least one of the following: whether a symmetric antenna structure or an asymmetric antenna structure is deployed at the terminal device 220; or a respective number of capability value set corresponding to each specific type of capability value set.

In some embodiments, the capability-related information further indicates an association relationship among the plurality of capability value sets.

In some embodiments, the capability-related information further indicates at least one of the following: whether the terminal device 220 supports to apply more than one capability value set concurrently; or the number of capability value set supported to be concurrently applied by the terminal device 220.

In some embodiments, the capability-related information further indicate at least one of the following: whether the terminal device 220 supports to determine the feedback state of the correspondence report; whether the terminal device 220 supports to report a correspondence report for downlink transmission; whether the terminal device 220 supports to report a state of a capability value set; whether the terminal device 220 supports to obtain the first correspondence with a time restriction requirement; or a number of capability value sets comprised in a correspondence report supported by the terminal device 220.

In some embodiments, the network device 210 transmits at least one configuration to be used by the terminal device 220 to the terminal device 220. The at least one configuration indicating at least one of the following: association relationships between at least one transmission parameter and a capability value set, a time domain behavior of the correspondence report, information about time restriction for obtaining the first correspondence, or a number of capability value sets associated with one correspondence report.

In some embodiments, the at least one transmission parameter comprising at least one of the following: a resource for transmitting SRS, a resource for transmitting PUCCH, a transmission configuration indicator state, or a resource for transmitting downlink RS.

In some embodiments, the correspondence report is configured with a first periodicity by the at least one configuration, the first periodicity is aligned with a second periodicity of a beam report, and the first periodicity is a multiple of second periodicity.

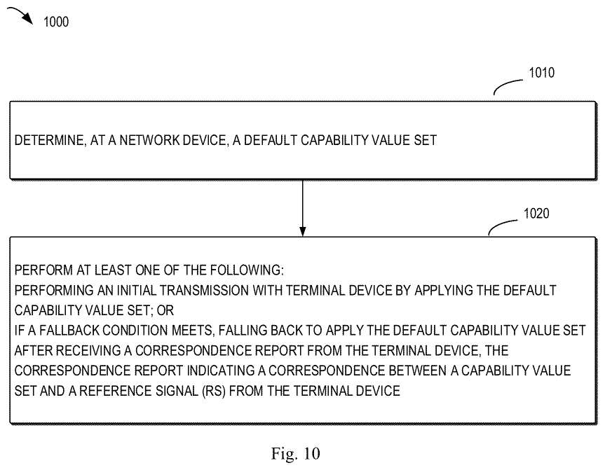

FIG. 10 illustrates a flowchart of an example method 1000 in accordance with some embodiments of the present disclosure. For example, the method 1000 can be implemented at the network device 210 as shown in FIG. 2.

At block 1010, terminal device 220 determines a default capability value set.

At block 1020, terminal device 220 performs at least one of the following: performing an initial transmission with terminal device 220 by applying the default capability value set; or if a fallback condition meets, falling back to apply the default capability value set after receiving a correspondence report from the terminal device 220, the correspondence report indicating a correspondence between a capability value set and a RS from the terminal device 220.

In some embodiments, the default value set is one of the following: a capability value set with a lower capability, a capability value set with a higher capability, a capability value set with a lower capability value set index, a capability value set with a higher capability value set index, a last used capability value set, a pre-defined capability value set, a capability value set configured either by the terminal device 220 or the network device 210.

In some embodiments, the network device 210 performs the initial transmission during a period between reporting a configuration of at least capability value set and transmitting a first correspondence report.

In some embodiments, the network device 210 performs the initial transmission with terminal device 220 comprising at least one of the following: transmitting, to the terminal device 220, a scheduling message generated according to the default capability value set; or receiving an uplink transmission from the terminal device 220 transmitted by applying the default capability value set.

In some embodiments, the network device 210 receives information about the default capability value set during a RA procedure.

In some embodiments, the network device 210 determines the fallback condition meets if one of the following: a period since receiving the correspondence report exceeds a pre-defined period; the capability value set associated with the correspondence report is configure with a higher capability; the correspondence report is aperiodic; occur one of a switch of BWP, a switch of CC, an activation of secondary cell and a cross cell scheduling; or the terminal device 220 is operated in a DRX mode.

### Example Devices

In some example embodiments, the terminal device 220 comprises circuitry configured to: transmit a correspondence report to a network device 210, the correspondence report indicating a first correspondence between at least one first capability value set and at least one first RS and communicate with the network device 210 according to a feedback state of the correspondence report, the feedback state being one of the following: an ACK, or a NACK.

In some embodiments, the circuitry is further configured to: receive a message from the network device 210. The message indicates the feedback state of the correspondence report and is at least one of the following: a TCI activation command at least partially associated with the at least one RS indicated by the correspondence report, a PDCCH order to trigger a RA procedure, a signaling for controlling the transmit power of the terminal device 220, a message to trigger the terminal device 220 to report a correspondence report, a message for activating a SRS transmission, a message for activating a CSI report transmission.

In some embodiments, the circuitry is further configured to: expect to receive the message indicating the feedback state of the correspondence report if at least one of the follow: the at least one first correspondence between at least one first capability value set and at least one first RS associated with the correspondence report is at least partially different from at least one second correspondence applied at the terminal device 220; the at least one first correspondence between at least one first capability value set and at least one first RS associated with the correspondence report is at least partially different from at least one second correspondence associated with the latest correspondence report; the at least one first capability value set associated with the correspondence report is at least partially different from at least one second capability value set currently applied at the terminal device 220; the at least one first RS associated with the correspondence report is at least partially different from at least one second RS applied at the terminal device 220; the correspondence report is configured with a specific time domain behavior, or identity information of a capability value set of the at least one capability value set indicates a specific state of capability value set.

In some embodiments, the state of capability value set is one of the following: a capability value set being used for uplink, a capability value set being used for downlink, or an application state of a capability value set indicating whether the capability value set has been applied or is to be applied.

In some embodiments, the circuitry is further configured to: determine the feedback state of the correspondence report to be NACK in response to: failing to receive a message indicating the feedback state of the correspondence report within a certain period after transmitting the correspondence report; or receiving a message to trigger the terminal device 220 to report an aperiodic or semi-persistent correspondence report after transmitting the correspondence report.

In some embodiments, the circuitry is further configured to: apply the at least one first capability value set associated with the first correspondence in response to one of the following: receiving, from the network device 210, a message indicating an ACK for the correspondence report, or transmitting a SRS after receiving the message indicating the ACK from the network device 210.

In some embodiments, the circuitry is further configured to: apply the at least one first capability value set associated with the first correspondence in response to one of the following: transmitting the correspondence report; or a period since transmitting the correspondence report exceeding a pre-configured period.

In some embodiments, if there are a plurality of RSs indicated by the first correspondence, the circuitry is further configured to: transmit an uplink transmission with a spatial domain transmission filter associated with an RS of the plurality of RSs with a best signal quality.

In some embodiments, the circuitry is further configured to: disable applying the at least one first capability value set associated with the first correspondence if fail to receive a message indicating the feedback state of the correspondence report within a certain period after transmitting the correspondence report; or receive a message indicating a NACK for the correspondence report.

In some embodiments, the terminal device 220 is communicating with the network device 210 by applying at least one second capability value set associated with a second correspondence. The circuitry is further configured to: continue to apply the at least one second capability value set associated with the second correspondence after transmitting the correspondence report for a certain period.

In some embodiments, the terminal device 220 is communicating with the network device 210 by applying at least one second capability value set associated with a second correspondence. The circuitry is further configured to: continue to apply the at least one second capability value set associated with the second correspondence after transmitting the correspondence report until one of the following: receiving a message indicating an ACK for the correspondence report from the network device 210, or transmitting a further correspondence report to the network device 210 after transmitting the correspondence report.

In some embodiments, the circuitry is further configured to: reset an accumulation of power control adjustment state in response to applying the first correspondence.

In some embodiments, the circuitry is further configured to: generate the correspondence report based on a parameter of time restriction configured by the network device 210 for obtaining the first correspondence.

In some embodiments, the correspondence report further indicates identity information for each of the capability value set indicated in the correspondence report.

In some embodiments, the identity information indicates at least one of the following: an index of a capability value set, an index of a panel deployed at the terminal device 220 and associated with the capability value set, or a state of the capability value set.

In some embodiments, a bit size of the identity information is determined based on at least one of the following: a first number of capability value sets supported by the terminal device 220, or a second number of the states of the capability value set supported by the terminal device 220.

In some embodiments, the circuitry is further configured to: transmit capability-related information of the terminal device 220 to the network device 210. The capability-related information indicates a plurality of capability value sets, a capability value set of the plurality of capability value sets comprising at least one of the following: identity information of the capability value set, a maximum number of sounding reference signal SRS ports, a coherent type, a maximum number of uplink layers, a maximum number of downlink layers, a maximum number of RS ports, a maximum number of codewords, or a maximum number of MIMO layers.

In some embodiments, each of the plurality of capability value sets corresponds to a specific type of capability value set, and the capability-related information further indicates at least one of the following: whether a symmetric antenna structure or an asymmetric antenna structure is deployed at the terminal device 220; or a respective number of capability value set corresponding to each specific type of capability value set.

In some embodiments, the capability-related information further indicates an association relationship among the plurality of capability value sets.

In some embodiments, the capability-related information further indicates at least one of the following: whether the terminal device 220 supports to apply more than one capability value set concurrently; or the number of capability value set supported to be concurrently applied by the terminal device 220.

In some embodiments, the capability-related information further indicate at least one of the following: whether the terminal device 220 supports to determine the feedback state of the correspondence report; whether the terminal device 220 supports to report a correspondence report for downlink transmission; whether the terminal device 220 supports to report a state of a capability value set; whether the terminal device 220 supports to obtain the first correspondence with a time restriction; or a number of capability value sets comprised in a correspondence report supported by the terminal device 220.

In some embodiments, the circuitry is further configured to: receive from the network device 210, at least one configuration to be used by the terminal device 220, the at least one configuration indicating at least one of the following: association relationships between at least one transmission parameter and a capability value set, a time domain behavior of the correspondence report, information about a time restriction for obtaining the first correspondence, report quantity, or a number of capability value sets associated with one correspondence report.

In some embodiments, the at least one transmission parameter comprising at least one of the following: a resource for transmitting SRS, a resource for transmitting PUCCH, a transmission configuration indicator state, or a resource for transmitting downlink RS.

In some embodiments, the circuitry is further configured to: perform a SRS transmission based on both of the at least one configuration and one or more capability value sets currently applied at the terminal device 220.

In some embodiments, if a value of a parameter of repetition comprised in an RS resource set is on, the circuitry is further configured to: perform at least of the following: disabling reporting the correspondence report, or transmitting the correspondence report associated with one RS, transmitting the first correspondence report with one capability value set index regardless of the configured number of capability value set indexes; or transmitting the correspondence report without comprising information about an RS.

In some example embodiments, the terminal device 220 comprises circuitry configured to: determine a default capability value set; and perform at least one of the following: performing an initial transmission with network device 210 by applying the default capability value set; or if a fallback condition meets, falling back to apply the default capability value set after transmitting a correspondence report to the network device 210, the correspondence report indicating a correspondence between a capability value set and a RS to the network device 210.

In some embodiments, the default value set is one of the following: a capability value set with a lower capability, a capability value set with a higher capability, a capability value set with a lower capability value set index, a capability value set with a higher capability value set index, a last used capability value set, a pre-defined capability value set, a capability value set configured either by the terminal device 220 or the network device 210.

In some embodiments, the circuitry is further configured to: perform the initial transmission during a period between reporting a configuration of at least capability value set and transmitting a first correspondence report.

In some embodiments, the circuitry is further configured to: perform the initial transmission with network device 210 comprising at least one of the following: receiving, from the network device 210, a scheduling message generated according to the default capability value set; or transmitting an uplink transmission with the network device 210 by applying the default capability value set.

In some embodiments, the circuitry is further configured to: transmit information about the default capability value set during a RA procedure.

In some embodiments, the circuitry is further configured to: determine the fallback condition meets if the terminal device 220 fails to receive a message indicating an ACK for the correspondence report after transmitting the correspondence report for a certain duration.

In some embodiments, the circuitry is further configured to: determine the fallback condition meets if the terminal device 220 receives a message indicating an ACK for the correspondence report at a transmission occasion for receiving the message after transmitting the correspondence report for a certain duration.

In some embodiments, the circuitry is further configured to: determine the fallback condition meets if the terminal device 220 receives a message indicating a NACK for the correspondence report.

In some embodiments, the circuitry is further configured to: determine the fallback condition meets if a period since transmitting the correspondence report exceeds a pre-defined period.

In some embodiments, the circuitry is further configured to: determine the fallback condition meets if the capability value set associated with the correspondence report is configure with a higher capability.

In some embodiments, the circuitry is further configured to: determine the fallback condition meets if the correspondence report is aperiodic.

In some embodiments, the circuitry is further configured to: determine the fallback condition meets if a switch of BWP, a switch of CC, an activation of secondary cell or a cross cell scheduling occurs.

In some embodiments, the circuitry is further configured to: determine the fallback condition meets if the terminal device 220 is operated in a DRX mode.

In some example embodiments, the network device 210 comprises circuitry configured to: determine receives a correspondence report from a terminal device 220, the correspondence report indicating a first correspondence between at least one first capability value set and at least one first RS; communicate with the terminal device 220 according to a feedback state of the correspondence report, the feedback state being one of the following: an ACK, or a NACK.

In some embodiments, the circuitry is further configured to: transmit a message to the terminal device 220. The message indicates the feedback state of the correspondence report and is at least one of the following: a TCI activation command at least partially associated with the at least one RS indicated by the report, a PDCCH order to trigger a RA procedure, a signaling for controlling the transmit power of the terminal device 220, a message to trigger the terminal device 220 to report a correspondence report, a message for activating a SRS transmission, a message for activating a CSI report transmission.

In some embodiments, the circuitry is further configured to: transmit the message indicating the feedback state of the correspondence report if at least one of the follow: the at least one first correspondence between at least one first capability value set and at least one first RS associated with the correspondence report is at least partially different from at least one second correspondence applied at the terminal device 220; the at least one first correspondence between at least one first capability value set and at least one first RS associated with the correspondence report is at least partially different from at least one second correspondence associated with the latest correspondence report; the at least one first capability value set associated with the correspondence report is at least partially different from at least one second capability value set currently applied at the terminal device 220; the at least one first RS associated with the correspondence report is at least partially different from at least one second RS applied at the terminal device 220; the correspondence report is configured with a specific time domain behavior, or identity information of a capability value set of the at least one capability value set indicates a specific state of capability value set.

In some embodiments, the state of the capability value set is one of the following: the capability value set being used for uplink, the capability value set being used for downlink, or an application state of a capability value set indicating whether the capability value set has been applied or is to be applied.

In some embodiments, if the network device 210 determines that the feedback state of the correspondence report is NACK, the circuitry is further configured to: transmit a message to the terminal device 220. The message to trigger the terminal device 220 to report an aperiodic or semi-persistent correspondence report after receiving the correspondence report.

In some embodiments, the circuitry is further configured to: apply the at least one first capability value set associated with the first correspondence in response to one of the following: transmitting, to the terminal device 220, a message indicating an ACK for the correspondence report, or receiving a SRS after transmitting the message indicating the ACK to the terminal device 220.

In some embodiments, the circuitry is further configured to: apply the at least one first capability value set associated with the first correspondence in response to one of the following: receiving the correspondence report; or a period since receiving the correspondence report exceeding a pre-configured period.

In some embodiments, if there are a plurality of RSs indicated by the first correspondence, the circuitry is further configured to: receive an uplink transmission with a spatial domain transmission filter associated with an RS of the plurality of RSs with a best signal quality.

In some embodiments, the circuitry is further configured to disable applying the at least one first capability value set associated with the first correspondence in accordance with a determination that the feedback state of the first correspondence report is NACK.

In some embodiments, the network device 210 is communicating with the terminal device 220 by applying the at least one second capability value set associated with a second correspondence. The circuitry is further configured to continue to apply the at least one second capability value set associated with the second correspondence after receiving the first correspondence report for a certain period.

In some embodiments, the network device 210 is communicating with the terminal device 220 by applying the at least one second capability value set associated with a second correspondence. The circuitry is further configured to continue apply the at least one second capability value set associated with the second correspondence after receiving the first correspondence report until one of the following: transmitting a message indicating an ACK for the correspondence report to the terminal device 220, or receiving a further correspondence report from the terminal device 220 after receiving the correspondence report.

In some embodiments, the correspondence report further indicates identity information for each of the capability value set indicated in the correspondence report.

In some embodiments, the identity information indicates at least one of the following: an index of a capability value set, an index of a panel deployed at the terminal device 220 and associated with the capability value set, or a state of the capability value set.

In some embodiments, a bit size of the identity information is determined based on at least one of the following: a first number of capability value sets supported by the terminal device 220, or a second number of the states of the capability value set supported by the terminal device 220.

In some embodiments, the circuitry is further configured to receive capability-related information of the terminal device 220 from the terminal device 220. The capability-related information indicating a plurality of capability value sets, a capability value set of the plurality of capability value sets comprising at least one of the following: identity information of the set of capability parameters, a maximum number of sounding reference signal SRS ports, a coherent type, a maximum number of uplink layers, a maximum number of downlink layers, a maximum number of RS ports, a maximum number of codewords, or a maximum number of MIMO layers.

In some embodiments, each of the plurality of capability value sets corresponds to a specific type of capability value set, and the capability-related information further indicates at least one of the following: whether a symmetric antenna structure or an asymmetric antenna structure is deployed at the terminal device 220; or a respective number of capability value set corresponding to each specific type of capability value set.

In some embodiments, the capability-related information further indicates an association relationship among the plurality of capability value sets.

In some embodiments, the capability-related information further indicates at least one of the following: whether the terminal device 220 supports to apply more than one capability value set concurrently; or the number of capability value set supported to be concurrently applied by the terminal device 220.

In some embodiments, the capability-related information further indicate at least one of the following: whether the terminal device 220 supports to determine the feedback state of the correspondence report; whether the terminal device 220 supports to report a correspondence report for downlink transmission; whether the terminal device 220 supports to report a state of a capability value set; whether the terminal device 220 supports to obtain the first correspondence with a time restriction requirement; or a number of capability value sets comprised in a correspondence report supported by the terminal device 220.

In some embodiments, the circuitry is further configured to transmit at least one configuration to be used by the terminal device 220 to the terminal device 220. The at least one configuration indicating at least one of the following: association relationships between at least one transmission parameter and a capability value set, a time domain behavior of the correspondence report, information about time restriction for obtaining the first correspondence, or a number of capability value sets associated with one correspondence report.

In some embodiments, the at least one transmission parameter comprising at least one of the following: a resource for transmitting SRS, a resource for transmitting PUCCH, a transmission configuration indicator state, or a resource for transmitting downlink RS.

In some embodiments, the correspondence report is configured with a first periodicity by the at least one configuration, the first periodicity is aligned with a second periodicity of a beam report, and the first periodicity is a multiple of second periodicity.

In some example embodiments, the network device 220 comprises circuitry configured to: determine a default capability value set; perform at least one of the following: performing an initial transmission with terminal device 220 by applying the default capability value set; or if a fallback condition meets, falling back to apply the default capability value set after receiving a correspondence report from the terminal device 220, the correspondence report indicating a correspondence between a capability value set and a RS from the terminal device 220.

In some embodiments, the default value set is one of the following: a capability value set with a lower capability, a capability value set with a higher capability, a capability value set with a lower capability value set index, a capability value set with a higher capability value set index, a last used capability value set, a pre-defined capability value set, a capability value set configured either by the terminal device 220 or the network device 210.

In some embodiments, the circuitry is further configured to: perform the initial transmission during a period between reporting a configuration of at least capability value set and transmitting a first correspondence report.

In some embodiments, the circuitry is further configured to: perform the initial transmission with terminal device 220 comprising at least one of the following: transmitting, to the terminal device 220, a scheduling message generated according to the default capability value set; or receiving an uplink transmission from the terminal device 220 transmitted by applying the default capability value set.

In some embodiments, the circuitry is further configured to: receive information about the default capability value set during a RA procedure.

In some embodiments, the circuitry is further configured to: determine the fallback condition meets if one of the following: a period since receiving the correspondence report exceeds a pre-defined period; the capability value set associated with the correspondence report is configure with a higher capability; the correspondence report is aperiodic; occur one of a switch of BWP, a switch of CC, an activation of secondary cell and a cross cell scheduling; or the terminal device 220 is operated in a DRX mode.

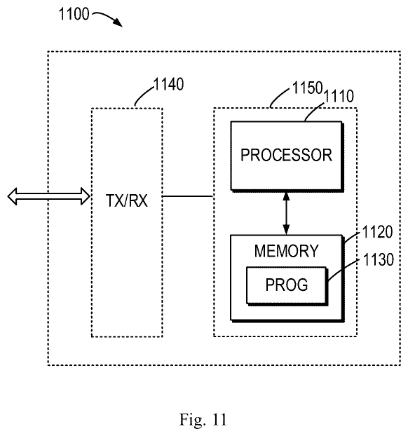

FIG. 11 is a simplified block diagram of a device 1100 that is suitable for implementing embodiments of the present disclosure. The device 1100 can be considered as a further example implementation of the terminal 220 and the network device 210 as shown in FIG. 2. Accordingly, the device 1100 can be implemented at or as at least a part of the terminal 220 and the network device 210.

As shown, the device 1100 includes a processor 1111, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the CNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2-10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-57. (canceled)

58. A method of a User Equipment (UE), the method comprising:
sending, to a network, a first Radio Resource Control (RRC) message which includes capability information of the UE, wherein the capability information includes an information element which indicates a maximum number of Sounding Reference Signal (SRS) antenna ports for a Channel State Information (CSI) report.

59. The method according to claim 58, further comprising:
sending, to the network, the CSI report which includes an index of UE capability value set indicating the maximum number of the SRS antenna ports.

60. The method according to claim 59,
wherein the CSI report includes a plurality of indexes which consists of the index,
wherein the CSI report includes a plurality of CSI-RS Resource Indicator (CRI) or SS/PBCH Block Resource Indicator (SSBRI) which correspond to the plurality of indexes respectively, and
wherein the CSI report includes a plurality of Reference Signal Receive Power (RSRP) which correspond to the plurality of indexes respectively.

61. The method according to claim 59,
wherein the CSI report includes a plurality of indexes which consists of the index,
wherein the CSI report includes a plurality of CSI-RS Resource Indicator (CRI) or SS/PBCH Block Resource Indicator (SSBRI) which correspond to the plurality of indexes respectively, and
wherein the CSI report includes a plurality of Signal to Interference Plus Noise Ratio (SINR) which correspond to the plurality of indexes respectively.

62. The method according to claim 59,
wherein information for a CSI-RS Resource Set is not reported in the CSI report in a case where a repetition for the CSI-RS Resource Set is set to on.

63. The method according to claim 58, further comprising:
receiving, from the network, a second RRC message which includes configuration information for the CSI report, wherein the configuration information includes a time domain behavior and a report quantity.

64. The method according to claim 63,
wherein the time domain behavior is periodic, semi-persistent, or aperiodic.

65. A method of a Radio Access Network (RAN) node, the method comprising:
receiving, from a User Equipment (UE), a first Radio Resource Control (RRC) message which includes capability information of the UE, wherein the capability information includes an information element which indicates a maximum number of Sounding Reference Signal (SRS) antenna ports for a Channel State Information (CSI) report.

66. The method according to claim 65, further comprising:
receiving, from the UE, the CSI report which includes an index of UE capability value set indicating the maximum number of the SRS antenna ports.

67. The method according to claim 66,
wherein the CSI report includes a plurality of indexes which consists of the index,
wherein the CSI report includes a plurality of CSI-RS Resource Indicator (CRI) or SS/PBCH Block Resource Indicator (SSBRI) which correspond to the plurality of indexes respectively, and
wherein the CSI report includes a plurality of Reference Signal Receive Power (RSRP) which correspond to the plurality of indexes respectively.

68. The method according to claim 66,
wherein the CSI report includes a plurality of indexes which consists of the index,
wherein the CSI report includes a plurality of CSI-RS Resource Indicator (CRI) or SS/PBCH Block Resource Indicator (SSBRI) which correspond to the plurality of indexes respectively, and
wherein the CSI report includes a plurality of Signal to Interference Plus Noise Ratio (SINR) which correspond to the plurality of indexes respectively.

69. The method according to claim 66,
wherein information for a CSI-RS Resource Set is not reported in the CSI report in a case where a repetition for the CSI-RS Resource Set is set to on.

70. The method according to claim 65, further comprising:
sending, to the UE, a second RRC message which includes configuration information for the CSI report, wherein the configuration information includes a time domain behavior and a report quantity.

71. The method according to claim 70,
wherein the time domain behavior is periodic, semi-persistent, or aperiodic.
